(19) United States
(12) Patent Application Publication
(10) Pub. No.: US 2024/0102819 A1
(43) Pub. Date: Mar. 28, 2024

(54) TRANSPORTATION MODE SPECIFIC NAVIGATION USER INTERFACES

(71) Applicant: Apple Inc., Cupertino, CA (US)

(72) Inventor: Nicholas G. SAMPLE, Broomfield, CO (US)

(21) Appl. No.: 18/473,204

(22) Filed: Sep. 22, 2023

Related U.S. Application Data
(60) Provisional application No. 63/377,014, filed on Sep. 24, 2022.

(51) Int. Cl. G01C 21/36; G01C 21/34; G06Q 10/02; G06Q 50/30

(52) U.S. Cl. CPC G01C 21/3664; G01C 21/3423; G01C 21/343; G06Q 10/02; G06Q 50/30

(57) ABSTRACT

In some embodiments, an electronic device facilitates display of and interaction with navigation directions including multiple modes of transportation. In some embodiments, an electronic device configures a route with multiple destinations and multiple modes of transportation. In some embodiments, the electronic device detects a first user input corresponding to a request to add a first destination to a route using a first mode of transportation, and in response, the electronic device adds the first destination using the first mode of transportation to the route. In some embodiments, the electronic device detects a second user input corresponding to a request to add a second destination to the route using a second mode of transportation, different from the first mode of transportation and in response, the electronic device adds the second destination using the second mode of transportation to the route.

### CROSS-REFERENCE TO RELATED APPLICATIONS

This application claims the benefit of U.S. Provisional Application No. 63/377,014, filed Sep. 24, 2022, the content of which is herein incorporated by reference in its entirety for all purposes.

### FIELD OF THE DISCLOSURE

This relates generally to user interfaces associated with providing navigation directions using multiple modes of transportation that change based on detected contextual information and user interfaces for configuring a route with multiple destination and multiple modes of transportation.

### BACKGROUND OF THE DISCLOSURE

User interaction with electronic devices has increased significantly in recent years. These devices can be devices such as computers, tablet computers, televisions, multimedia devices, mobile devices, and the like. In some circumstances, users want a seamless transition between navigating to a destination using multiple transportation modes.

### SUMMARY OF THE DISCLOSURE

Some embodiments described in this disclosure are directed to one or more electronic devices that detect a change in contextual information indicating a change to a mode of transportation and a change to navigation directions. Some embodiments described in this disclosure are directed to one or more electronic devices that detect a user input corresponding to a request to add a destination and a mode of transportation for each segment of a multiple destination route. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 5I-5N provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein.

FIGS. 6A-6H illustrate exemplary ways of facilitating display of and interaction with navigation directions including multiple modes of transportation in accordance with some embodiments of the disclosure.

FIG. 7 is a flow diagram illustrating a method of facilitating display of and interaction with navigation directions including multiple modes of transportation in accordance with some embodiments of the disclosure.

FIGS. 8A-8I illustrate exemplary ways of configuring a route with multiple destinations and multiple modes of transportation in accordance with some embodiments of the disclosure.

FIG. 9 is a flow diagram illustrating a method of configuring a route with multiple destinations and multiple modes of transportation in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices to present navigation directions that use multiple modes of transportation, including changing modes of transportation based on detected contextual information. There is also a need for electronic devices to add a destination and specify the mode of transportation for navigating to the added destination in a multiple destination route for navigation directions. Such techniques enhance user interactions with the electronic device by reducing the inputs needed to continue navigating when the mode of transportation changes and provide an efficient way of presenting information relevant to the mode of transportation which reduces the amount of time needed by a user to perform operations. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

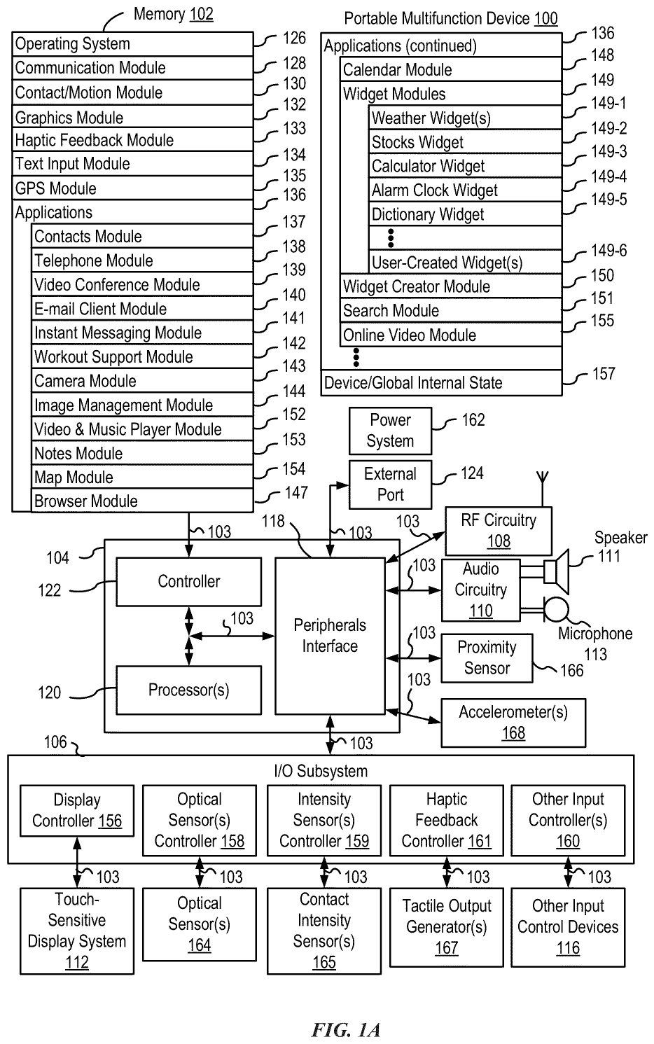

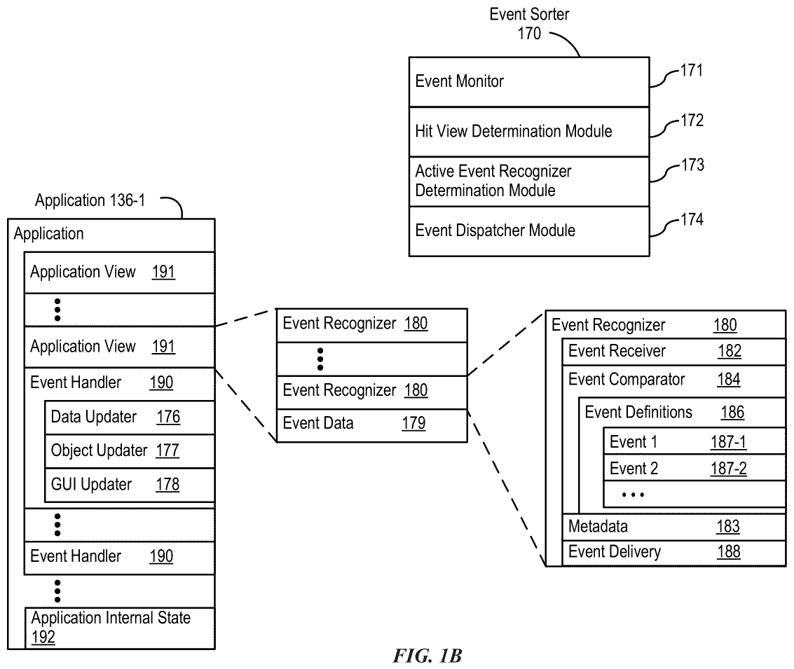

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

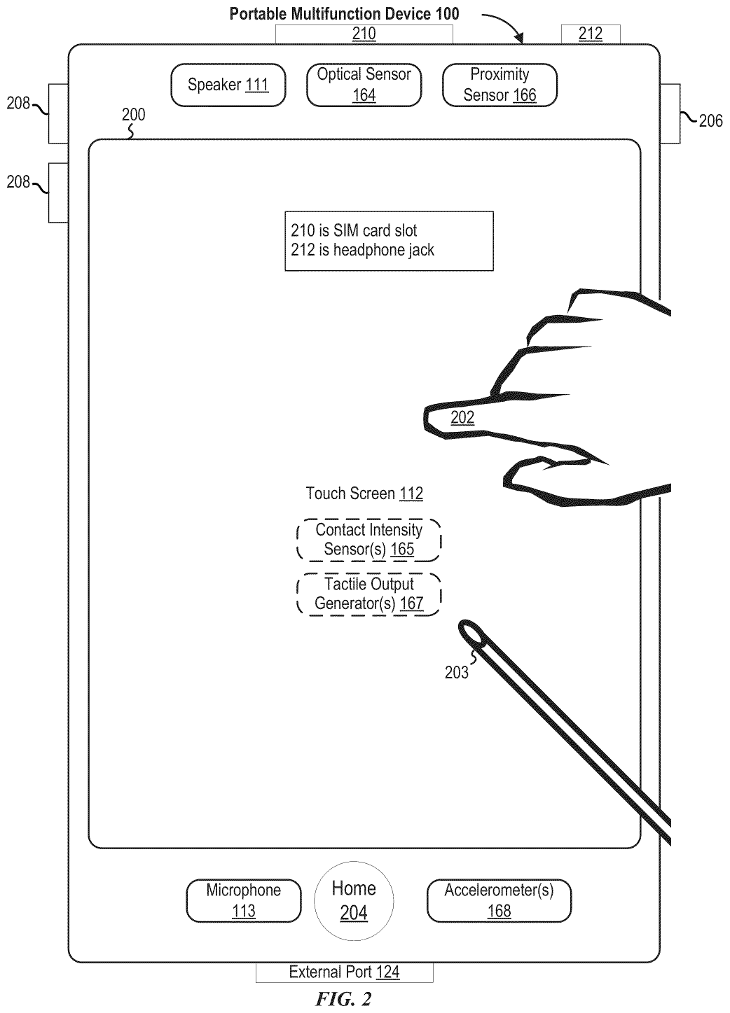

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

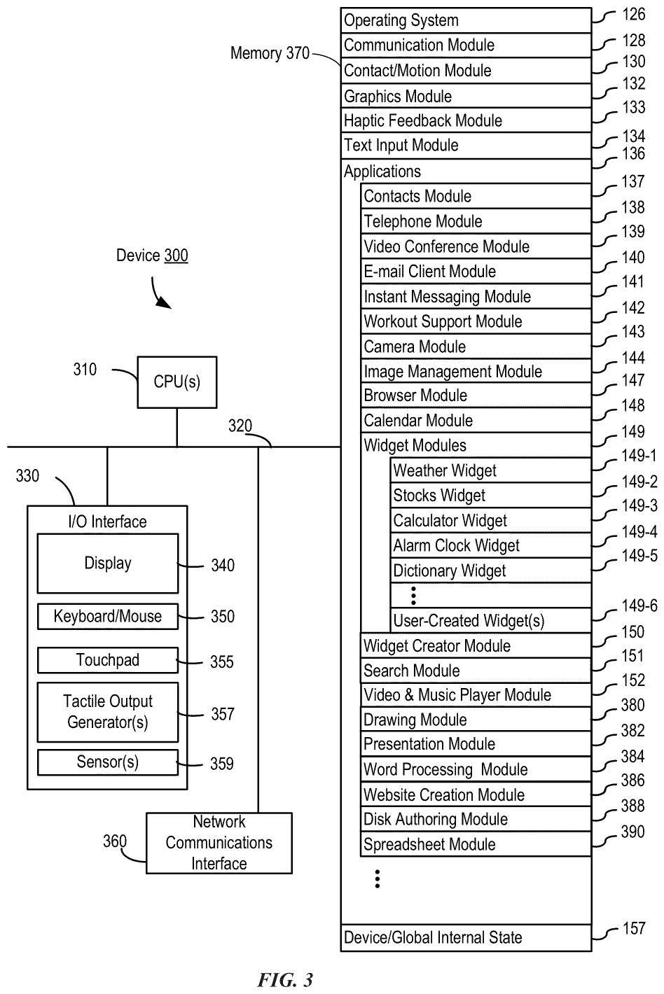

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

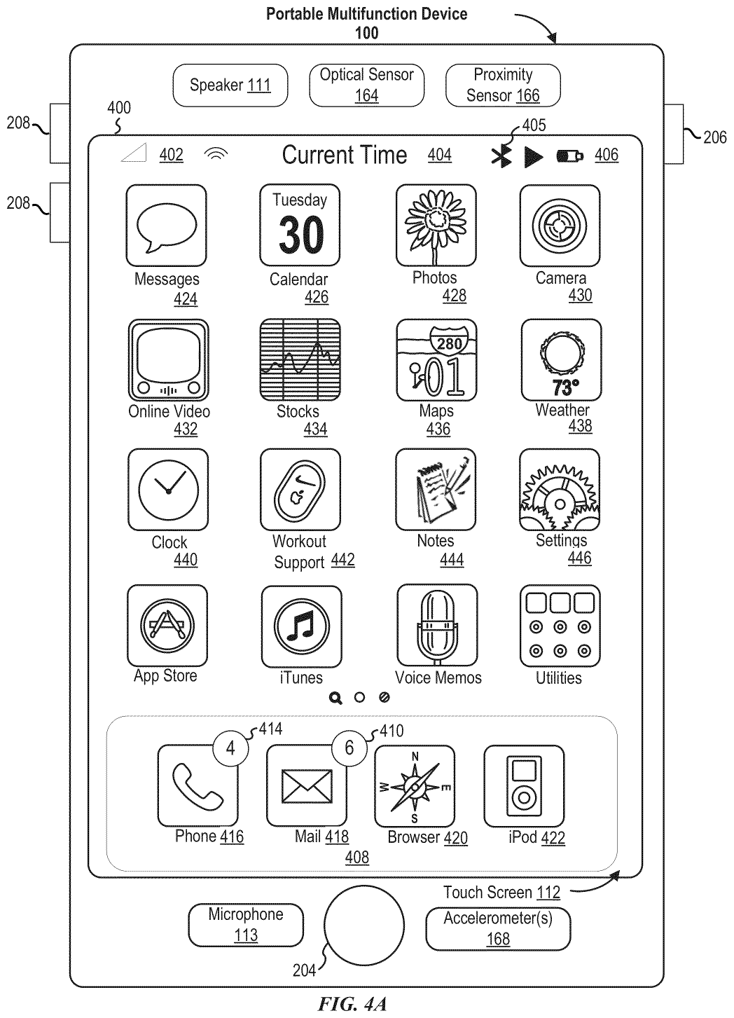

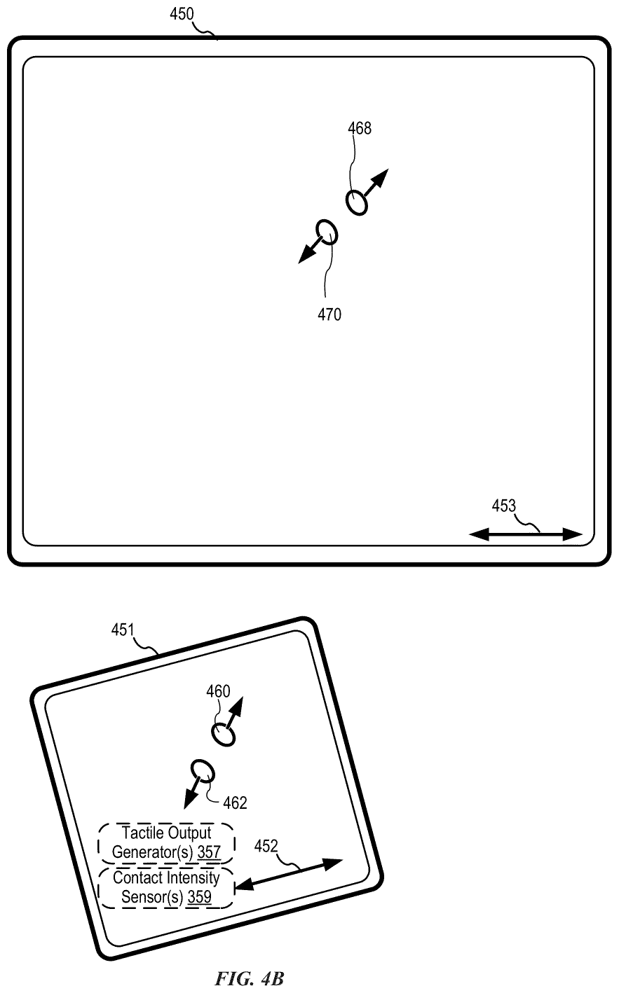

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

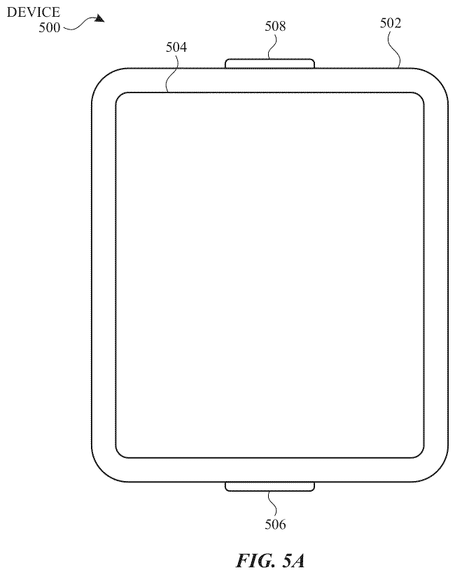

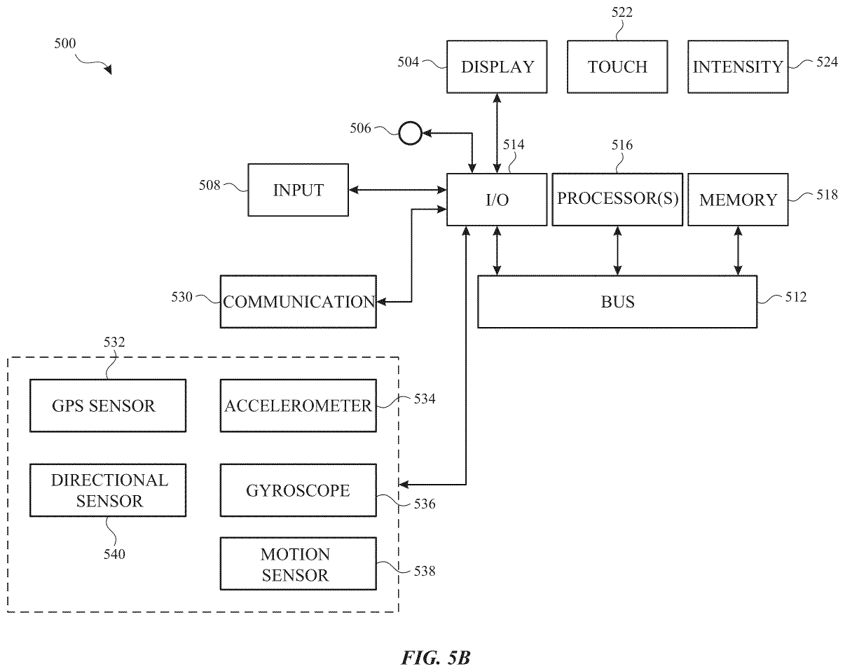

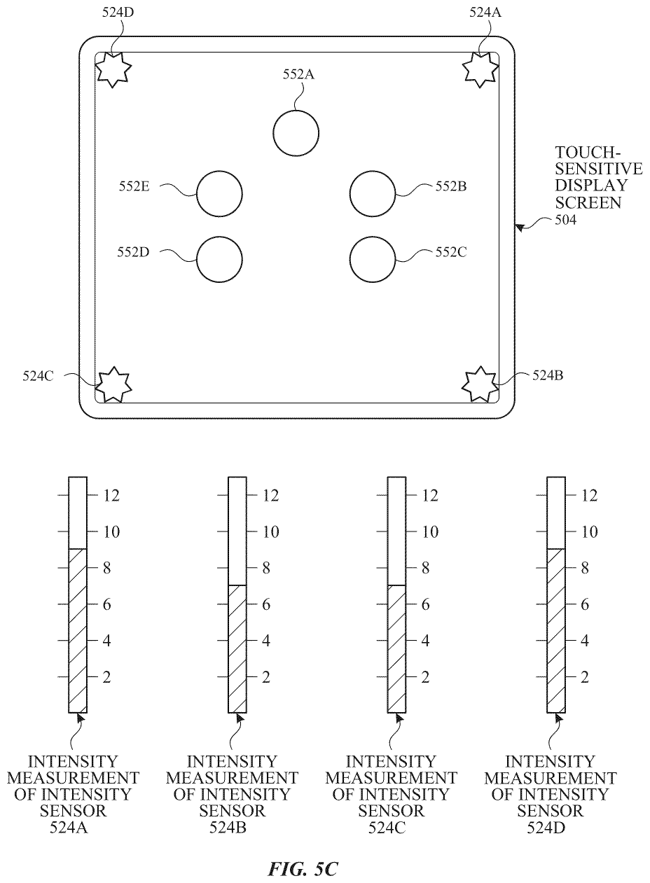

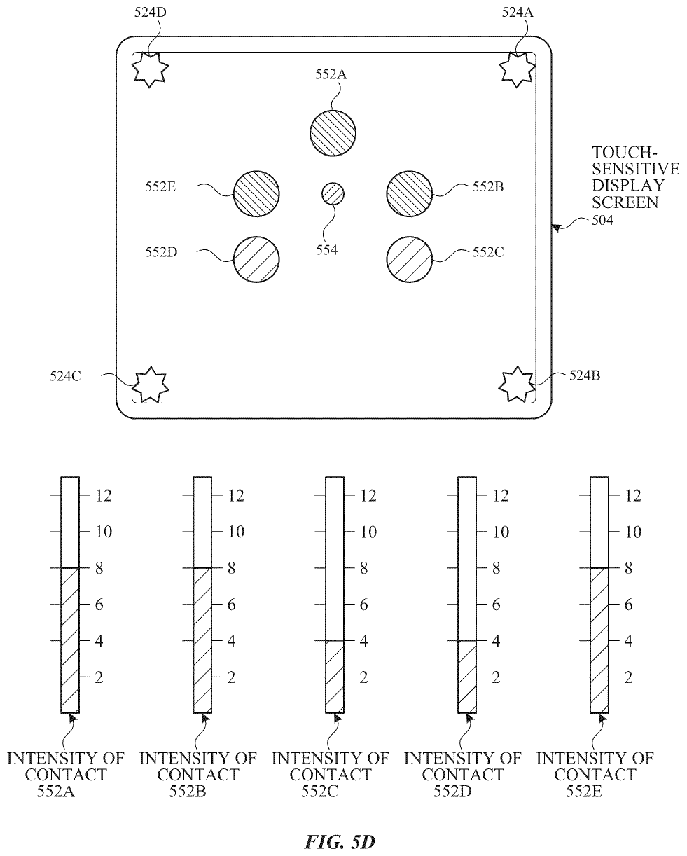

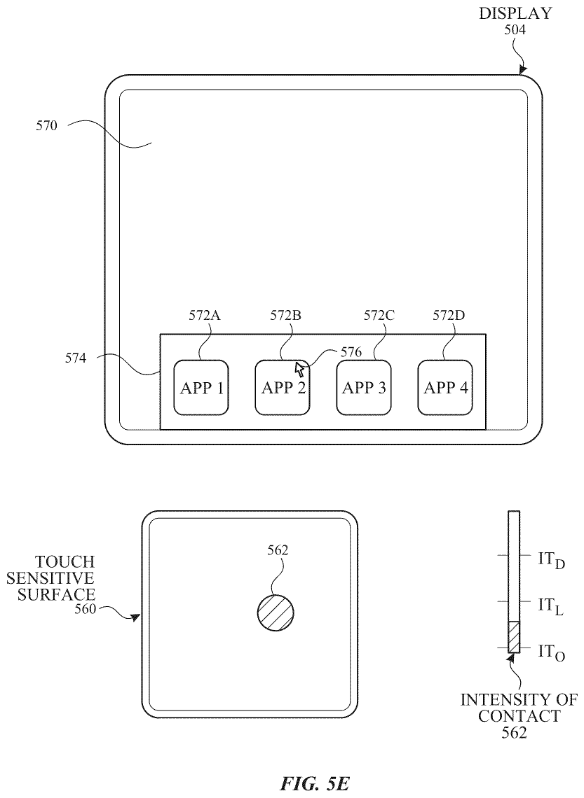

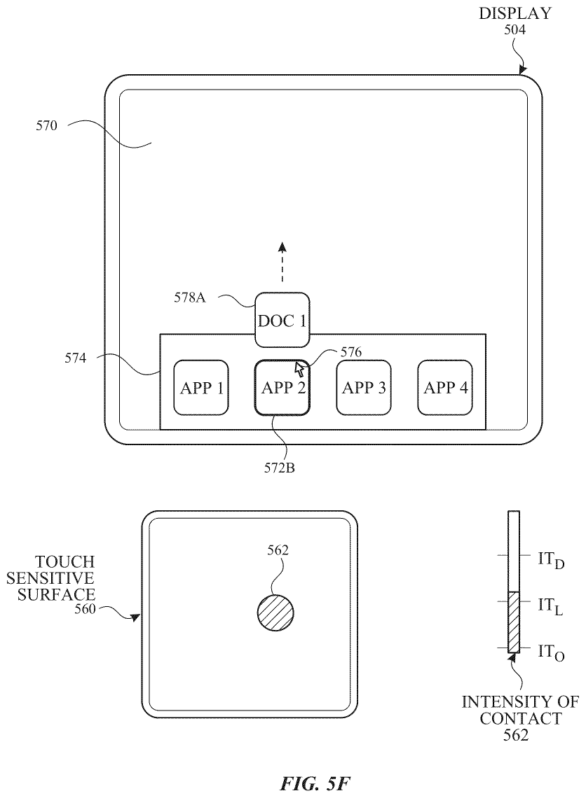

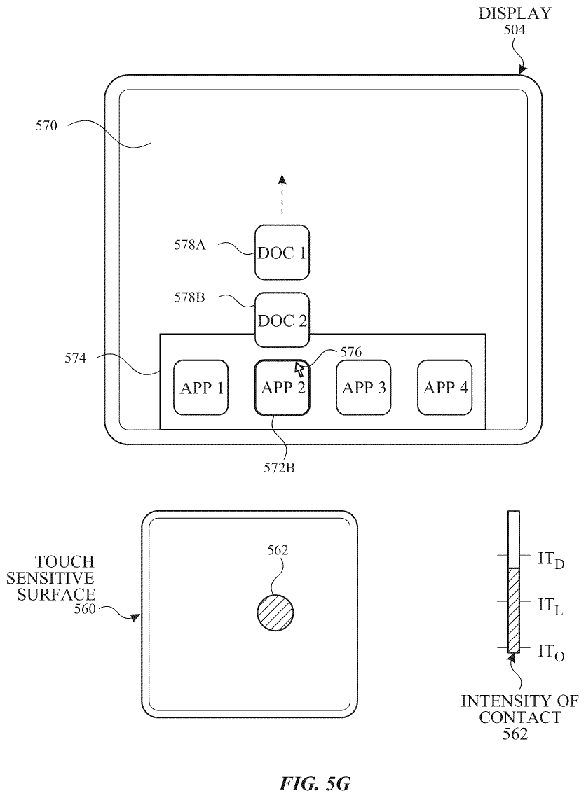

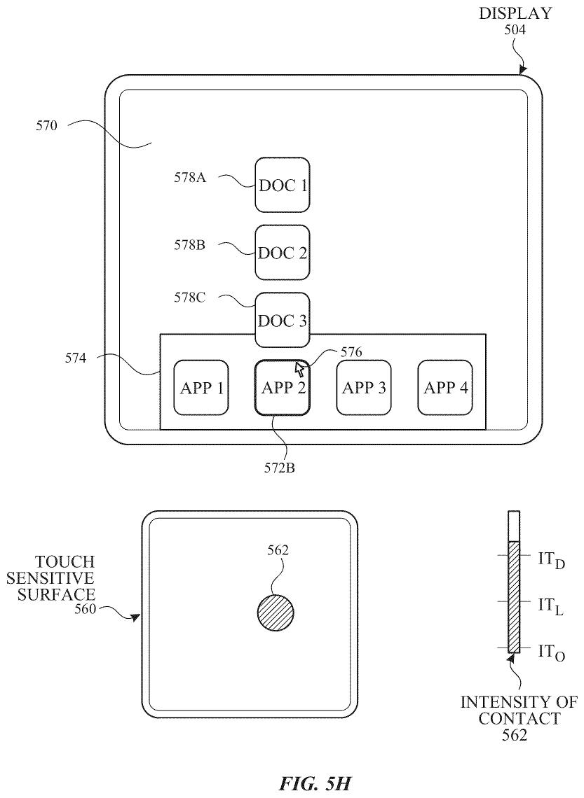

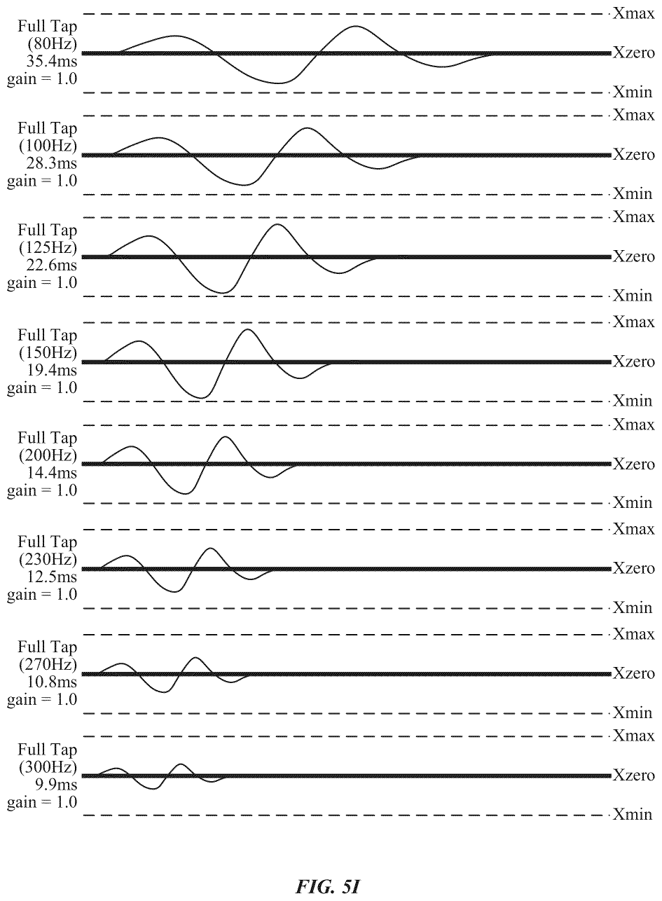

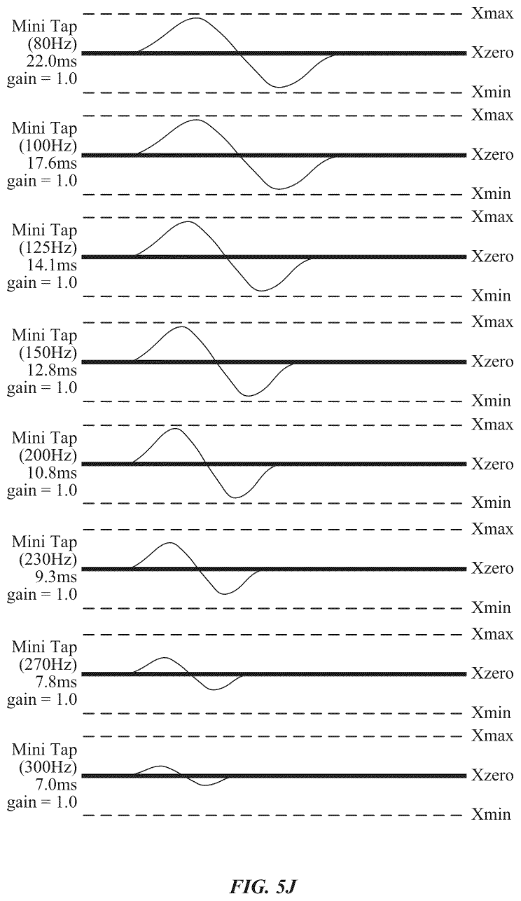

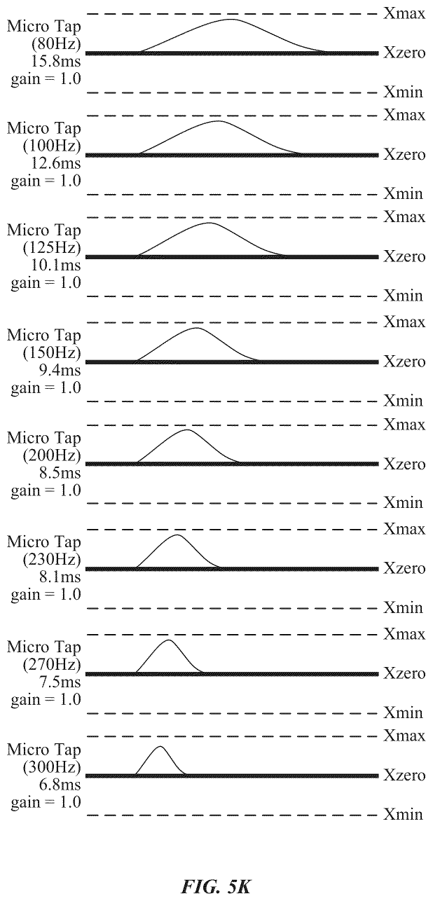

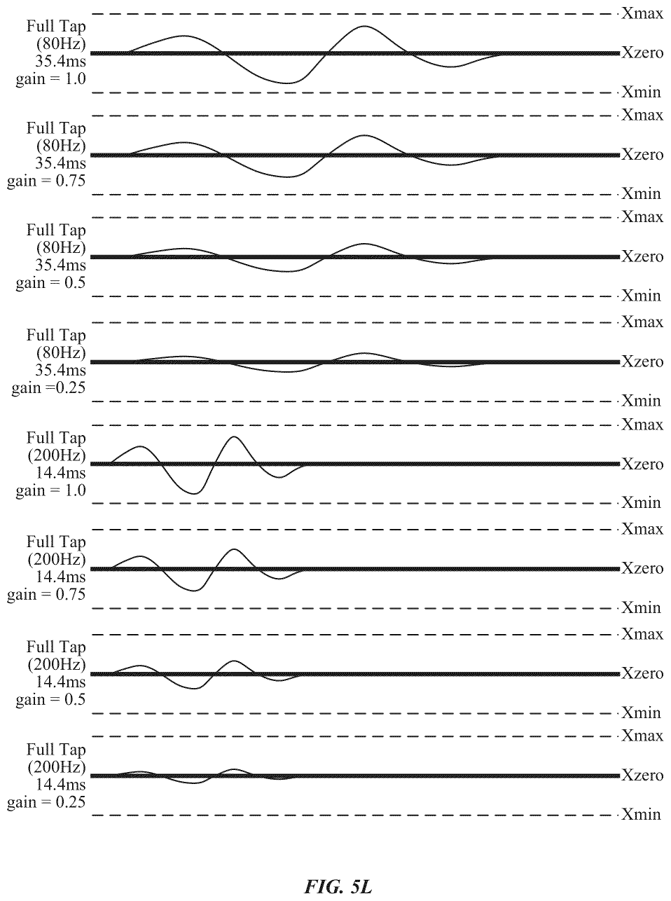

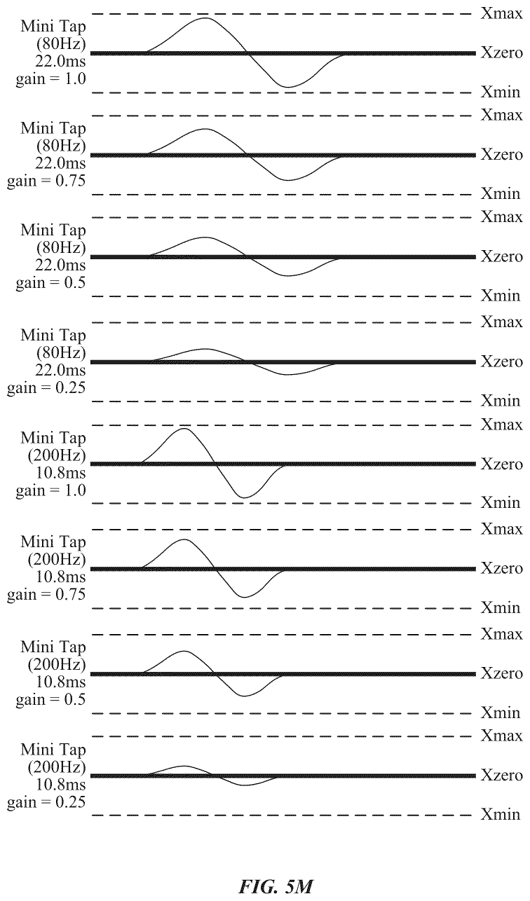

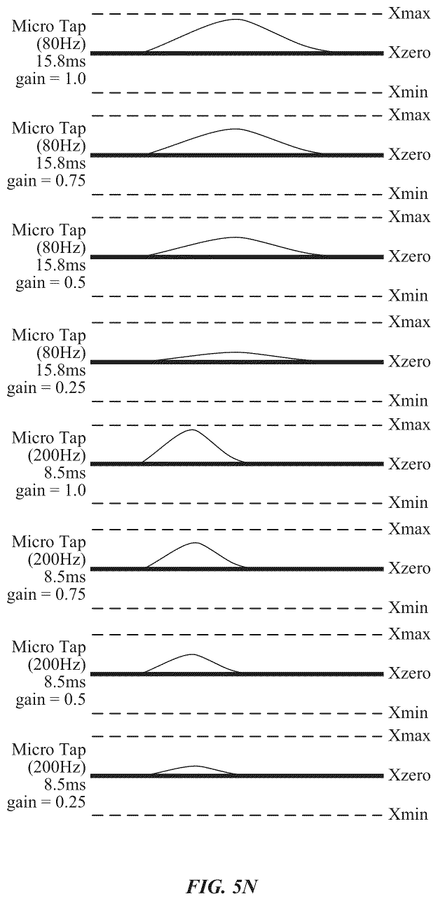

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

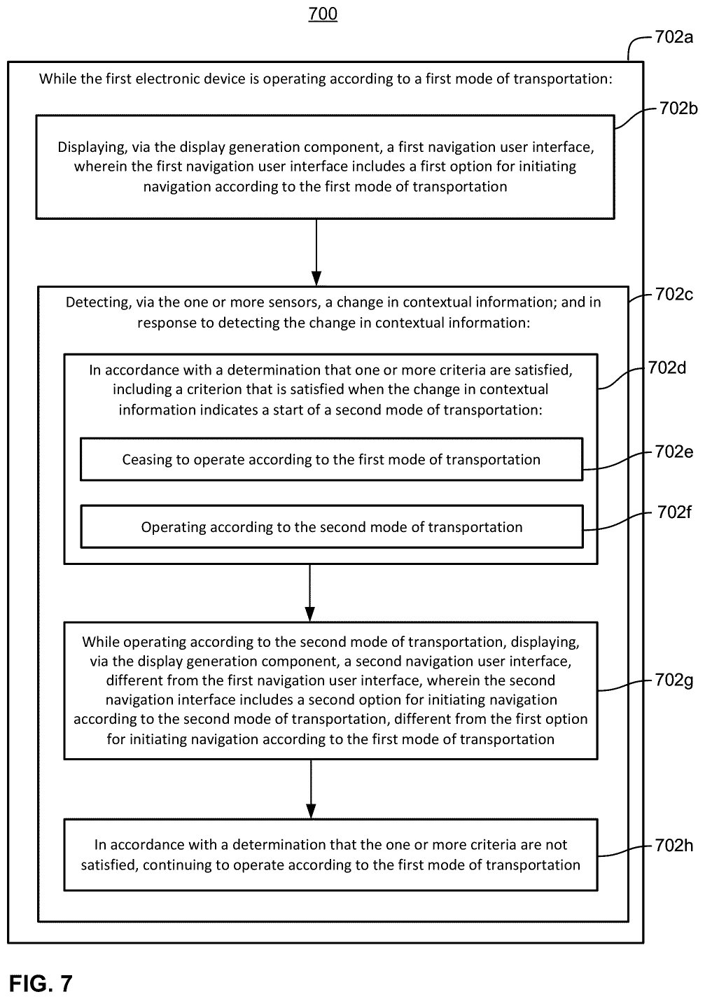

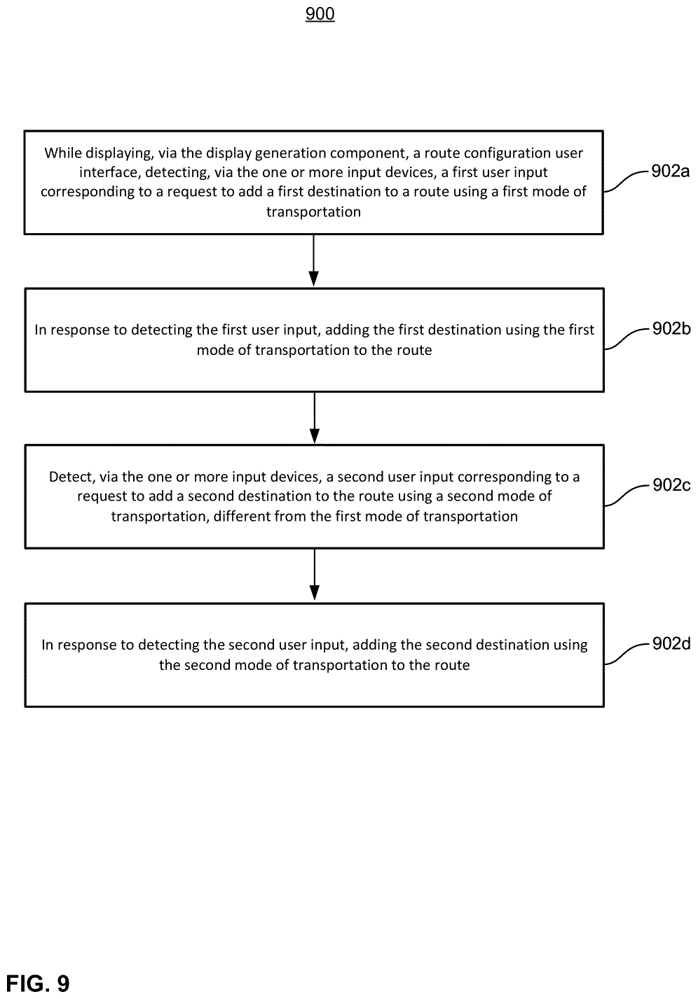

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A.(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT L”) in FIG. 5E, to an intensity above a deep press intensity threshold (e.g., “IT S”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

More specifically, FIGS. 5I-5K provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in these figures, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 5L-5N, which are each shown with variants having a gain of 1.0, 0.75, 0.5, and 0.25. As shown in FIGS. 5L-5N, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Nz, and 200 Hz).

FIGS. 5I-5N show tactile output patterns that have a particular waveform. The waveform of a tactile output pattern represents the pattern of physical displacements relative to a neutral position (e.g., Xzero) versus time that a moveable mass goes through to generate a tactile output with that tactile output pattern. For example, a first set of tactile output patterns shown in FIG. 5I (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 5J (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 5K (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 5I-5N include Xmin and Xmax values which represent the maximum and minimum extent of movement of the moveable mass. For larger electronic devices with larger moveable masses, there may be larger or smaller minimum and maximum extents of movement of the mass. The examples shown in FIGS. 5I-5N describe movement of a mass in one dimension, however similar principles would also apply to movement of a moveable mass in two or three dimensions.

As shown in FIGS. 5I-5K, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 5I-5N, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. 5I). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 5I-5K, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metrics (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 5I-5K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well. Table 1 below provides representative examples of tactile output/haptic feedback behaviors and configurations, and examples of their use with respect to the user interfaces for managing content-based tactile outputs that are illustrated and described herein.

TABLE 1

| Type of Tactile | | Textural |
|---|---|---|
| Output | | (continuous) or |
| Sequence | Waveform | Discrete |
| “Major″ | MiniTap at 180 Hz | Discrete |
| ″Minor″ | MicroTap at 80 Hz | Textural |
| ″Major-reduced″ | MiniTap at 200 Hz | Discrete |
| ″Minor-Reduced″ | MicroTap at 200 Hz | Discrete |

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UP”) and associated processes that are implemented on an electronic device, such as portable multifunction device 100, device 300, or device 500.

User Interfaces and Associated Processes

Changing Mode of Transportation of Navigation Directions

Users interact with electronic devices in many different manners. In some embodiments, an electronic device presents navigation directions from a first physical location to a second physical location. In some embodiments, while navigating to the second physical location, the electronic device detects, based on contextual information, that the mode of transportation of the user has changed. The embodiments described below provide ways in which an electronic device presents navigation directions that use multiple modes of transportation, including changing modes of transportation based on the detected contextual information. Enhancing interactions with an electronic device reduces the amount of time needed by a user to perform operations, and thus reduces the power usage of the electronic device and increases battery life for battery-powered electronic devices. The ability for an electronic device to change the mode of transportation of the navigation directions enhances user interactions with the electronic device by reducing the inputs needed to continue navigating when the mode of transportation changes. When a person uses an electronic device, that person is optionally referred to as a user of the electronic device.

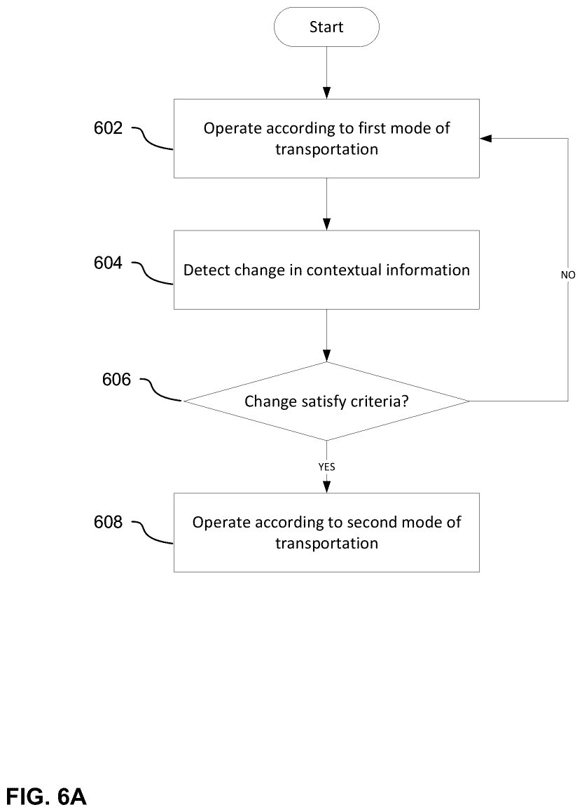

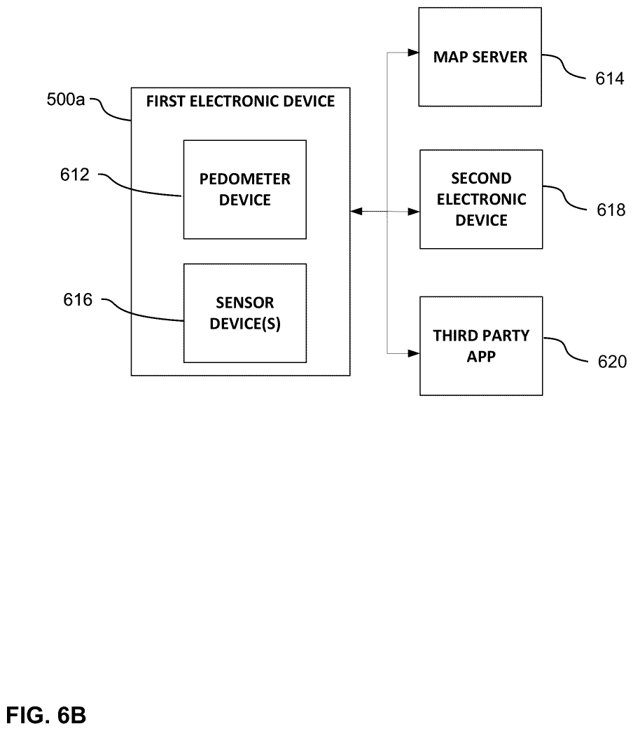

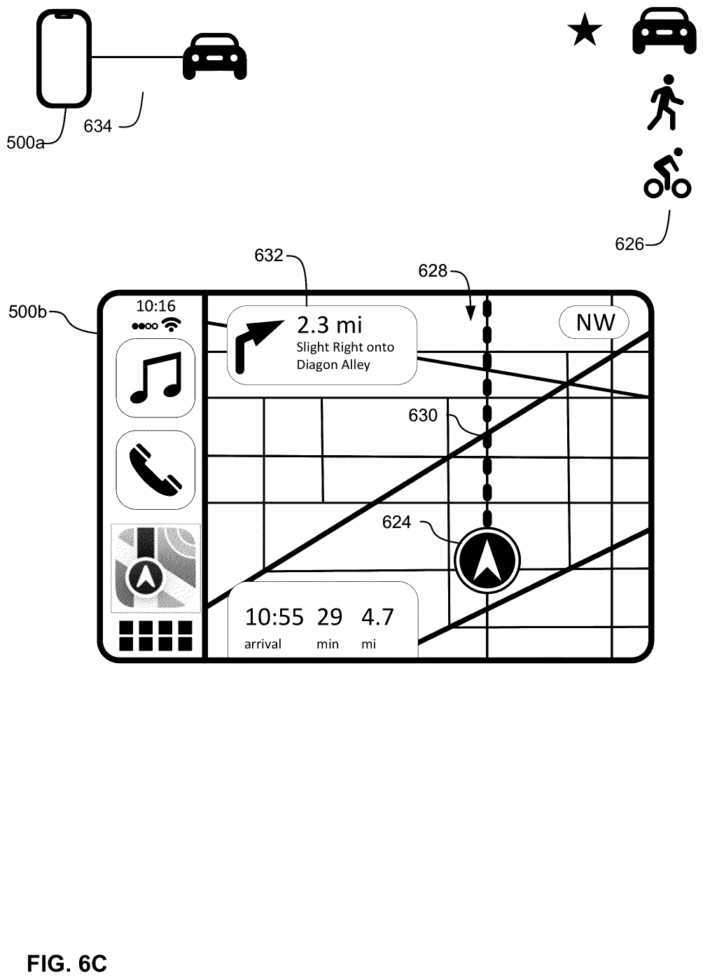

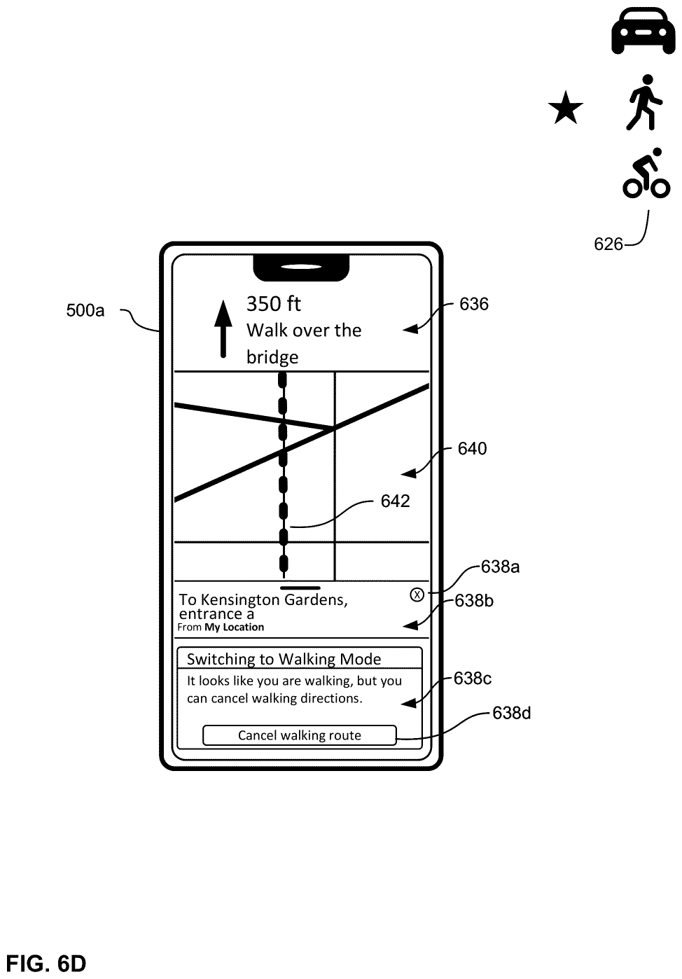

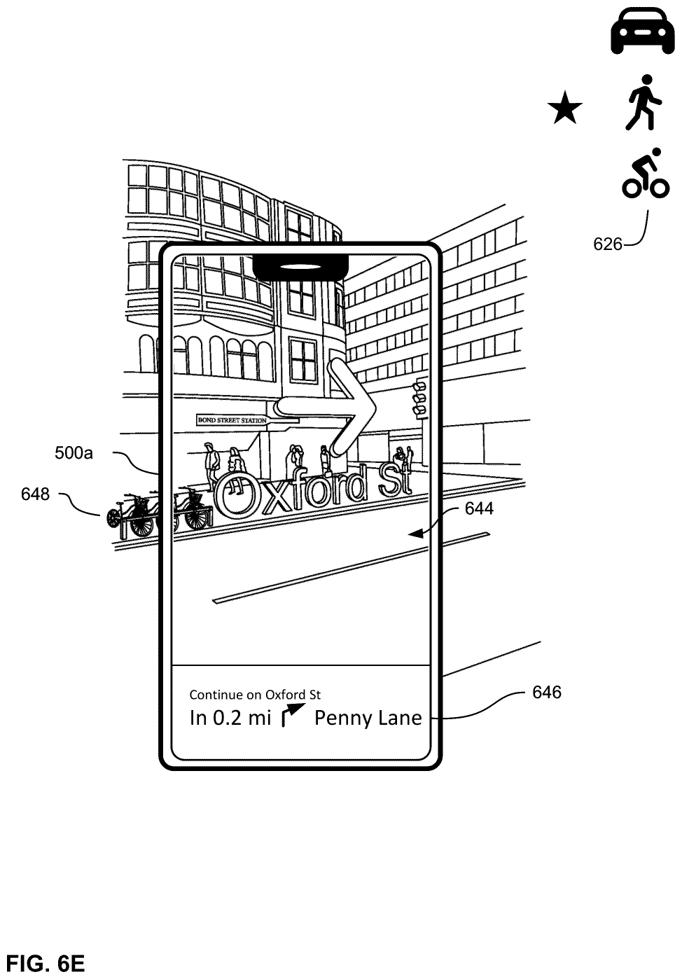

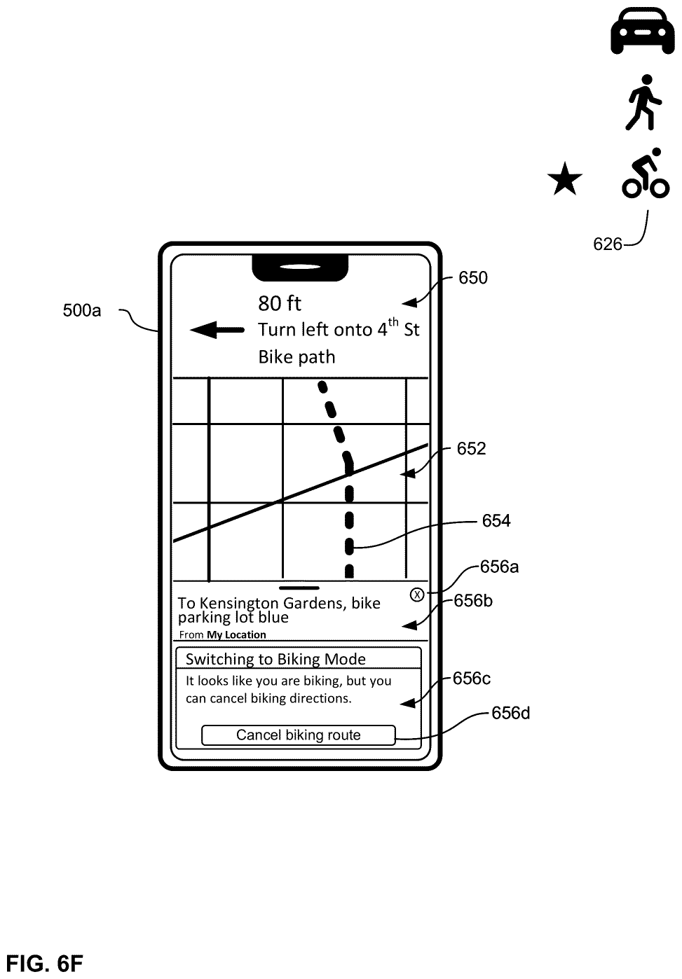

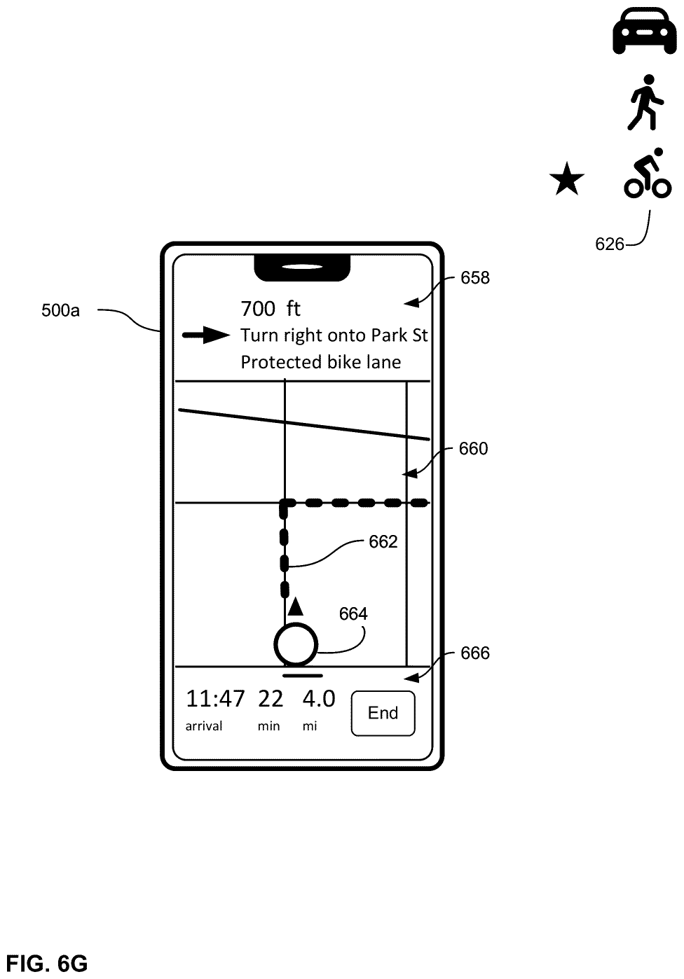

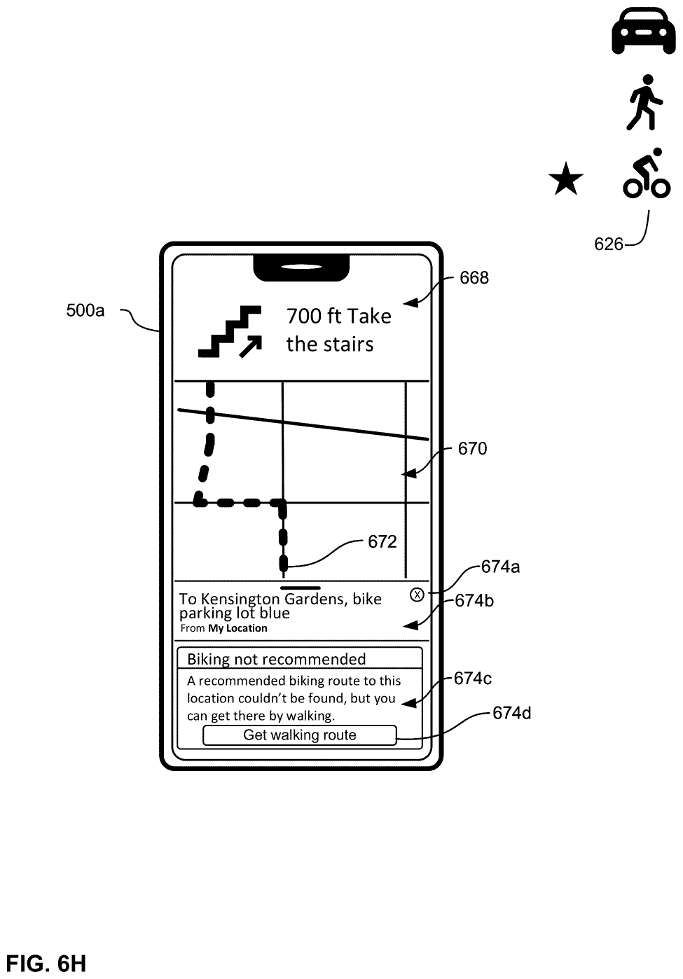

FIGS. 6A-6H illustrate exemplary ways of facilitating display of and interaction with navigation directions including multiple modes of transportation in accordance with some embodiments of the disclosure. The embodiments in these figures are used to illustrate the processes described below, including the processes described with reference to FIG. 7.

FIG. 6A is an example method for transitioning from a first mode of transportation to a second mode of transportation while presenting navigation directions in accordance with some embodiments. The method generally begins at block 602 where a first electronic device (e.g., mobile device) operates according to a first mode of transportation, such as driving in a motorized vehicle. For example, the first electronic device presents navigation directions for driving. Other modes of transportation are described with reference to method 700. In some embodiments, operating according to the first mode of transportation includes displaying a navigation user interface of a mapping application having navigation directions according to the first mode of transportation. The navigation user interface will be described in more detail below with reference to FIGS. 6C-6H and with reference to method 700.

Following block 602, the process flow proceeds to block 604 where the first electronic device detects a change in contextual information in some embodiments. For example, the change in contextual information indicates that the user of the first electronic device is no longer using or is no longer associated with the first mode of transportation (e.g., the user is no longer driving in the motorized vehicle). As will be described in more detail with reference to method 700, in some embodiments, the first electronic device detects the change in contextual information based on one or more motion signal measurements of the first electronic device and/or other sensor data optionally utilized in determining that the user of the first electronic device is no longer using the first mode of transportation. For example, the first electronic device detects that the speed of movement of the first electronic device has reduced from a speed associated with driving to a speed associated with walking or riding a bike. As another example, the first electronic device detects movement of the first electronic device corresponding to walking, running, or cycling, such as repetitive movement at a cadence associated with one of these modes of transportation.

Following block 604, the process flow proceeds to block 606 where the first electronic device determines whether the change in contextual information satisfies one or more criteria in some embodiments. If, for example, the first electronic device determines no, the change in contextual information does not satisfy the one or more criteria, the process flow proceeds to block 602 where the first electronic device continues to operate according to the first mode of transportation (e.g., driving in the motorized vehicle). For example, the sensed contextual information is consistent with the first mode of transportation. In some embodiments, the one or more criteria include criterion that is satisfied when the change in contextual information indicates a start of a second mode of transportation as will described in more detail below and with reference to method 700. In some embodiments, continuing to operate according to the first mode of transportation includes continuing to display the navigation user interface of the mapping application having navigation directions according to the first mode of transportation.

Returning to block 606, where the first electronic device determines whether the change in contextual information satisfies one or more criteria, in some embodiments, if the first electronic device determines yes, the change in contextual information does satisfy the one or more criteria, the process flow proceeds to block 608 where the first electronic device operates according to the second mode of transportation. In some embodiments, the second mode of transportation is different from the first mode of transportation. For example, the second mode of transportation includes biking or another mode of transportation other than driving in the motorized vehicle. In some embodiments, the first electronic device 500a selects the second mode of transportation from a predetermined list of modes of transportation selected by the user as modes of transportation the user would like to see navigation directions for. In some embodiments, operating according to the second mode of transportation includes displaying the navigation user interface of the mapping application having navigation directions according to the second mode of transportation. In some embodiments, block 606 includes evaluating the contextual information to determine the mode of transportation corresponding to the second mode of transportation. For example, the first electronic device is able to determine which mode of transportation the user is currently using from a plurality of possible modes of transportation based on the contextual information.

In some embodiments, the first mode of transportation is not limited to driving and the second mode of transportation is not limited to biking. For example, the first electronic device is capable of transitioning between driving, biking, public transportation, rideshare and/or walking.

In some embodiments, with reference to FIG. 6B, the first electronic device 500a may be configured to analyze the contextual information received and/or captured from one or more modules and/or devices to determine whether the contextual information indicates the start of the second mode of transportation. The one or more modules and/or devices may include pedometer device 612, map server 614, sensor device(s) 616, second electronic device 618, and a third party application 620 (e.g., one or more applications designed to execute on mobile device operating systems), all of which may be in communication with the first electronic device 500a. In some embodiments, the first electronic device 500a detects the change in contextual information including one or more environment and/or user context data and may determine whether the change in contextual information indicates the start of the second mode of transportation. For example, map server 614 provides map data to the mapping application in response to a request made by the first electronic device 500a for more information. In some embodiments, the map data includes different map regions and information describing streets, roadways, highways, and/or points of interest in the map region. In some embodiments, the first electronic device 500a may determine that the contextual information indicates the start of the second mode of transportation (e.g., biking). For example, the determination that the mode of transportation has changed is made based on data sensed by a pedometer device 612. In some embodiments, pedometer device 612 is in communication with the first electronic device 500a. In some embodiments, the first electronic device 500a includes the pedometer device (e.g., a built-in pedometer device). In some embodiments, the first electronic device 500a compares the number of steps detected by the pedometer device 612 to the predefined threshold numbers of steps respectively associated with walking, biking, riding in a motorized vehicle, or riding in public transportation to determine the mode of transportation.

In some embodiments, the determination of the change in contextual information is based on map data. In some embodiments, the first electronic device 500a requests new surrounding map data at the time of the contextual change to confirm the start of the second mode of transportation. For example, the new surrounding map data at the time of the contextual change may include a number of bike paths and thus confirms the start of the second mode of transportation. In some embodiments, the first electronic device 500a requests new map data after sensing a change in pedometer data from pedometer device 612. In some embodiments, the first electronic device 500a requests the new map data absent a change in pedometer data from pedometer device 612. In some embodiments, the first electronic device 500a requests new map data irrespective of a change in pedometer data, such as requesting new map data based on a different condition (e.g., data from sensor device(s) 616 and/or a predetermined amount of time passing).

In some embodiments, the first electronic device 500a may request location and/or orientation information from one or more other sensor device(s) 616 (e.g., accelerometer and/or gyroscope with the first electronic device) to determine or confirm the start of the second mode of transportation. Other sensor devices(s) are described in more detail with reference to method 700. In some embodiments, the first electronic device 500a may determine whether the first electronic device 500a is in communication with a second electronic device 618 (e.g., watch, tablet, or motorized vehicle display device). For example, if the electronic device 618 determines that the first electronic device 500a is in communication with a motorized vehicle display, the first electronic device 500a may determine or confirm the start of the second mode of transportation corresponding to driving a motorized vehicle. In some embodiments, the first electronic device 500a may determine user engagement with a third party app 620, such as a ridesharing app or rental bike app to determine or confirm the start of the second mode of transportation. For example, if the electronic device 618 determines that the first electronic device 500a is in communication with rental bike app, the first electronic device 500a may determine or confirm the start of the second mode of transportation corresponding to biking. Other modules and/or devices to determine whether the contextual information indicates the start of the second mode of transportation are described with reference to method 700.

FIGS. 6C-H illustrate an example transition from operating according to a first mode of transportation to operating according to a second mode of transportation. In some embodiments, the first electronic device 500a is configured to stream or share navigation data for presentation on a display of a second electronic device 622 while operating according to a mode of transportation corresponding to driving a motorized vehicle. For example, as indicated by legend 634 in FIG. 6C, the first electronic device 500a is in communication with a second electronic device 500b (e.g., motorized vehicle display device) to present a maps application user interface providing navigation directions along a route according to the first mode of transportation (e.g., driving a motorized vehicle). As indicated by legend 626 of FIG. 6C, the electronic device 610 is operating according to the first mode of transportation (e.g., driving), for example. FIG. 6C also shows an example of the second electronic device 500b providing navigation directions according to driving a motorized vehicle. In some embodiments, if the first electronic device 500a was presenting navigation directions for a different mode of transportation prior to presenting the driving directions, the first electronic device 500a changes to the driving directions in response to detecting the user of the first electronic device 500a entering the vehicle, such as detecting the second electronic device 500b in the vicinity of the first electronic device 500a.

In some embodiments, the maps application user interface includes a map 628 including a representation of the current location 624 of the first electronic device 500a and/or second electronic device 500b and an indication of the route 630 of the driving navigation directions. As shown in FIG. 6C, the maps application user interface includes an indication 632 of the next maneuver of the navigation directions to be performed according to the first mode of transportation, for example. In some embodiments, the indication includes an indication of the distance between the current location of the first electronic device 500a and/or the second electronic device 5002 and the location of the maneuver, an image representing the maneuver to be performed, and text describing the maneuver to be performed.

As will be described and shown below in the FIGS. 6D-6H, in some embodiments, the transition from operating according to the first mode of transportation to operating according to the second mode of transportation is automatic in response to the change in contextual information without requiring a user input to initiate the change in modes of transportation. For example, while the first electronic device 500a is operating according to the first mode of transportation (e.g., driving), the first electronic device 500a detects a change in contextual information indicative of starting the second mode of transportation corresponding to walking without detecting user input corresponding to a request to change from the first mode of transportation to the second mode of transportation. For example, the user equipped with the first electronic device 500a has gotten out of the car and has started walking. In some embodiments, the first electronic device 500a detects that the user has started walking based on pedometer data, other sensor data, and/or map data described above with reference to FIG. 6B. In some embodiments, the first electronic device 500a changes from providing driving directions to providing walking directions in accordance with a determination that the user of the first electronic device 500a has exited the vehicle, such as detecting the second electronic device 500b no longer in the vicinity of the first electronic device 500a. In some embodiments, the first electronic device 500a presents an indication recommending a change from driving to another mode of transportation in accordance with detecting a state of the driver of the vehicle, for example, if the driver is tired or irritated. In response, in some embodiments, the first electronic device 500a transitions from not displaying the driving navigation directions while operating in the first mode of transportation (e.g., driving) (e.g., because second electronic device 500b displays the driving directions) to displaying walking navigations directions while operating in the second mode of transportation (e.g., walking) as shown in FIG. 6D. In some embodiments, the first electronic device 500a transitions from displaying a driving navigation user interface including one or more elements of the driving user interface illustrated in FIG. 6C to displaying the walking navigation user interface illustrated in FIG. 6D.

FIG. 6D illustrates an example of the first electronic device 500a displaying a walking navigation user interface. As indicated by legend 626 of FIG. 6D, the electronic device 610 is operating according to the second mode of transportation, different from the first mode of transportation in the previous FIG. 6C. In some embodiments, in response to detecting the change in contextual data corresponding to changing from driving to walking, the first electronic device 500a displays an indication 638c of the first electronic device 500a transitioning from ceasing to operate according to the first mode of transportation (e.g., driving) to operating according to the second mode of transportation (e.g., walking). In some embodiments, as shown in 6D, the first electronic device 500a displays the indication 638a of the first electronic device 500a transitioning from ceasing to operate according to the first mode of transportation to the second mode of transportation overlaid on the map 640. In some embodiments, the indication 638a includes information related to operating according to the second mode of transportation, such as content 638b which optionally includes the location (e.g., “My Location”) of the first electronic device 500a when the change in contextual information was detected and the destination (e.g., “Kensington Gardens, entrance a”). In some embodiments, the location at which the navigation directions start is different for the first mode of transportation than it is for the second mode of transportation. For example, the first electronic device 500a starts navigating the in the first mode of transportation at the starting location of the route and starts navigating in the second mode of transportation at the location at which the contextual information indicates the change from the first mode of transportation to the second mode of transportation. In some embodiments, the indication 638a also includes content 638c notifying the user of operating according to the second mode of transportation and an option 638d to cancel operating according to the second mode of transportation. In some embodiments, as shown in FIG. 6D, the content 638c includes text content. Additionally or alternatively in some embodiments, the content 638c includes one or more still, animated, and/or video images.

In some embodiments, while operating according to the second mode of transportation, the first electronic device 500a presents user interface elements to enhance operating according to the second mode of transportation. For example, as shown in FIG. 6E, the first electronic device 500a presents an immersive augmented reality 644 concurrently with an indication 646 of a maneuver to be performed as part of the navigation directions according to the first mode of transportation. Other user interface elements presented by the first electronic device 106 to enhance operating according to a mode of transportation are described with reference to method 700.

In some embodiments, while operating according to the second mode of transportation corresponding to walking as indicated by legend 626 in FIG. 6E, the first electronic device 500a detects change in contextual information, such as the first electronic device 500a in communication with a bikeshare application. For example, the bikeshare application is associated with the bikes 648 in the vicinity of the first electronic device 500a, shown in the immersive augmented reality 644. In some embodiments, the change in contextual information further includes a change in speed indicative of operating according to a third mode of transportation corresponding to biking. In response, the first electronic device 500a displays an indication of the first electronic device 500a transitioning from ceasing to operate according to the second mode of transportation (e.g., walking) to operating according to the third mode of transportation (e.g., biking) as shown in FIG. 6F.

For example, as shown in FIG. 6F, the maps application user interface includes an indication 656a of the change in modes of transportation overlaid on the map 652. In some embodiments, the indication 656a includes information related to operating according to the third mode of transportation, such as content 656b which optionally includes the location (e.g., “My Location”) of the first electronic device 500a when the change in contextual information was detected and the destination (e.g., “Kensington Gardens, bike parking lot blue”). In some embodiments, the first electronic device 500a presents a different destination according to the changed mode of transportation. For example, while operating according to the third mode of transportation corresponding to biking, the navigation directions include navigating to a destination relevant to biking such as “bike parking lot blue,” whereas the destination in FIG. 6D while the first electronic device 500a was operating according to walking was “The Kensington Gardens, entrance a.” In some embodiments, the first electronic device 500a changes modes of transportation without changing the destination of the navigation directions. In FIG. 6F, in some embodiments, the indication 656a also includes content 656c notifying the user of operating according to the third mode of transportation and an option 656d to cancel operating according to the second mode of transportation.

FIG. 6G illustrates an example of the first electronic device 500a presenting navigation directions for biking. In some embodiments, while navigating to the destination according to the third mode of transportation corresponding to biking as shown in FIG. 6G and as indicated by legend 626, the first electronic device 106 presents a map 660 including a representation of the current location 664 of the first electronic device 500a and an indication of the route 662. FIG. 6G also shows content 658 representing the next maneuver of the navigation directions to be performed according to the third mode of transportation which includes an indication of the distance between the current location of the first electronic device 500a and the location of the maneuver, an image representing the maneuver to be performed, and text describing the maneuver to be performed, for example. In some embodiments, when the first electronic device 500a changes from operating according to the first mode of transportation to operating according to the second mode of transportation, the first electronic device 500a changes the route used to navigate to the destination. For example, as shown in FIG. 6G, while navigating using biking directions, the first electronic device 500a presents navigation directions for using a bike lane that was not used for walking and/or driving. While navigating according to the third mode of transportation, the first electronic device 106 includes information 666 related to the route, such as an estimated time of arrival, an estimated elapsed time remaining, and the distance remaining in the route as shown in FIG. 6G.

In some embodiments, after transitioning from the first mode of transportation to the second mode of transportation, the first electronic device 500a continues navigating according to the second mode of transportation for the remainder of the route of the navigation directions. In some embodiments, the first electronic device 500a navigates using the second mode of transportation until the end of the navigation route in accordance with a determination that the contextual information does not correspond to a further change in transportation mode. In some embodiments, in response to detecting contextual information corresponding to the change in transportation mode while navigating using the second mode of transportation, the first electronic device 500a changes to a third mode of transportation different from the second mode of transportation selected based on the contextual information. Thus, in some embodiments, the first electronic device 500a does not navigate to the end of the route using the second mode of transportation.

In some embodiments, the first electronic device 500a presents an option to switch from the current mode of transportation to a suggested mode of transportation, different from the current mode of transportation in operation. For example, in some embodiments, the first electronic device 106 may be configured to periodically or continuously track information provided by pedometer device 612, sensor device(s) 616, map server 614, second electronic device 618, and/or a third party application 620. In some embodiments, in response to the new information, the first electronic device 500a may suggest a mode of transportation.

For example, as shown in FIG. 6H, while the first electronic device 106 is displaying navigation directions according to the third mode of transportation corresponding to biking as indicated by legend 626, the navigation instructions include content 668 representing an upcoming maneuver of the navigation directions to be performed. In some embodiments, the first electronic device 106 determines that the maneuver (e.g., “taking stairs”) is not recommended for the third mode of transportation as described in more detail with reference to method 700. In response and as shown in FIG. 6H, the first electronic device 500a includes in the maps application user interface an indication 674a of the recommended change in transportation modes overlaid on the map 670. In some embodiments, the indication 674a includes information related to operating according to the third mode of transportation, such as content 674b which optionally includes the location (e.g., “My Location”) of the first electronic device 500a when the change in contextual information was detected and the destination (e.g., “Kensington Gardens, bike parking lot blue”). The user interface element 674a also includes content 674c notifying the user that operating according to the third mode of transportation is not recommended and an option 674d to change the mode of transportation to walking 656d.

Therefore, according to the above, the first electronic device 500a transitions between transportation modes while presenting navigation directions in accordance with changes in contextual information.

FIG. 7 is a flow diagram illustrating a method 700 of exemplary ways facilitating display of and interaction with navigation directions including multiple modes of transportation in accordance with some embodiments, such as in FIGS. 6A-6H. The method 700 is optionally performed at an electronic device such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways to facilitate display of and interaction with navigation directions including multiple modes of transportation. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at a first electronic device (e.g., 500a) in communication with a display generation component (e.g., 504) and one or more sensors. For example, the first electronic device is a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the first electronic device), a handheld device (e.g., external), and/or a controller (e.g., external), or a set-top box in communication one or more input devices (e.g., a remote control). In some embodiments, the display generation component is a display integrated with the first electronic device (optionally a touch screen display), external display such as a monitor, projector, television, or a hardware component (optionally integrated or external) for projecting a user interface or causing a user interface to be visible to one or more users. In some embodiments, the first electronic device is configured with the one or more sensors. The one or more sensors optionally include one or more motion sensors (e.g., pedometer, accelerometer, or gyroscope) described with reference to FIG. 5B that can measure the motion of the first electronic device. The one or more motion sensors optionally generate motion signal measurements. In some embodiments, the first electronic device analyzes the motion signal measurements for changes in magnitude and/or frequency to determine activity corresponding to modes of transportation. In some embodiments, the one or more sensors include sensors different from the one or more motion sensors described with reference to method 700.

In some embodiments, while the first electronic device is operating according to a first mode of transportation (702a), such as the driving mode of transportation as indicated by legend 626 in FIG. 6C, the first electronic device displays (702b), via the display generation component, a first navigation user interface, such as the user interface that includes driving navigation directions shown in FIG. 6C, wherein the first navigation user interface includes a first option for initiating navigation according to the first mode of transportation. In some embodiments, the first electronic device detects (702c), via the one or more sensors, a change in contextual information, such as the first electronic device 500a disconnecting from the second electronic device 500b in FIG. 6C. As used herein, the first navigation user interface optionally refers to a user interface of a mapping application. In some embodiments, the mapping application is installed and runs on the first electronic device and generates the first navigation user interface for display on the first electronic device. In some embodiments, the first navigation user interface is presented for display on a touch screen of a motor vehicle to which the first electronic device is connected (e.g., via a wired or wireless connection). In some embodiments, the first navigation user interface is simultaneously displayed on both the first electronic device and the touch screen of the motor vehicle. In some embodiments, the first option for initiating navigation according to the first mode of transportation is one of a plurality of options for initiating navigation according to a plurality of respective modes of transportation. As used herein, the first navigation presentation optionally provides a set of navigation directions from a first location (e.g., location of the first electronic device when navigation directions were requested or specified location inputted by the user via the first navigation user interface) to a second location (e.g., specified destination inputted by the user via the first navigation user interface). As used herein, the first mode of transportation optionally refers to a motorized vehicle, such as an automobile (e.g., driving directions). In some embodiments, the first navigation user interface includes the first option for initiating navigation according to another mode of transportation (e.g., bicycle, walking, transit, or transportation other than the motorized vehicle) different from the first mode of transportation. In some embodiments, the first option for initiating navigation according to the first mode of transportation includes navigation instructions, user interface elements, a visual appearance and/or layout based on the first mode of transportation. For example, when the first mode of transportation corresponds to the motorized vehicle, the first navigation user interface includes the first navigation presentation having a first navigation instructions, a first mapping information, a first navigation information, and/or a first set of features. For example, the first navigation instructions optionally include major roads such as highways. In some embodiments, the first electronic device prioritizes adding highways to the route to reduce travel time. In some embodiments, the first electronic device prioritizes adding to the route roads with bike paths and/or turns to avoid interactions with motorized vehicles while using a biking mode of transportation that would not otherwise be prioritized when using the motorized vehicle mode of transportation. In some embodiments, the first mapping information optionally includes major roads such as highways, traffic information, charging stations and/or rest stops. In some embodiments, the first navigation information includes speed limit, specific driving directions, and/or an estimated time of arrival to the specified destination. In some embodiments, the first set of features include initiating payments (for fuel/charge), presenting three-dimensional maps, presenting trip information (e.g., trip duration, fuel economy, and/or weather), and/or manipulating vehicle settings (e.g., air-conditioning, heated seats, and/or radio). For example, the first electronic device detects the motion signal measurements change from a first speed to a second speed, wherein the first speed is greater than the second speed. In some embodiments, the first speed is less than the second speed. In some embodiments, the change in contextual information relates to an activity of a user equipped with the first electronic device. For example, the first electronic device detects a change in user engagement with the first electronic device from a first level of engagement (e.g., browsing content, texting, scrolling, listening to audio, and/or talking) to a second level of engagement (e.g., absence of any user engagement and the first electronic device is asleep). In another example, the first electronic device detects a change in a physiological characteristic (e.g., heart rate and/or respiratory rate) of the user captured by the first electronic device. In some embodiments, an increased heart rate indicates the user is walking, biking, or jogging. In some embodiments, the change in contextual information indicates that the user is no longer using or is no longer associated with the first mode of transportation (e.g., the user is no longer driving or is no longer a passenger in the motorized vehicle). As will be described with reference to method 700, the motion signal measurements and/or other sensor data are optionally utilized in determining a current mode of transportation. In some embodiments, the first electronic device detects the change in contextual information while displaying the first navigation user interface. In some embodiments, the first electronic device detects the change in contextual information while not displaying the first navigation user interface.

In some embodiments, in response to detecting the change in contextual information, in accordance with a determination that one or more criteria are satisfied, including a criterion that is satisfied when the change in contextual information indicates a start of a second mode of transportation (702d), such as the walking mode of transportation indicated by legend 626 in FIG. 6D, wherein the change in contextual information is optionally a change in speed of the first electronic device 500a indicative of the user walking. For example, if the amount of change between the first speed and the second speed is greater than a first threshold amount (e.g., 15, 20, 25, 30, 35, 40, 45, 50, 60, 70, 80, 90, or 100 km/h), the amount of change optionally indicates the start of the second mode of transportation. Other indications of starting (or initiating a start of) the second mode of transportation will be described with reference to method 700. In some embodiments, the first electronic device detects the change in contextual information without detecting user input. For example, detecting user input is not part of the determination that one or more criteria are satisfied, including a criterion that is satisfied when the change in contextual information indicates a change from operating according to the first mode of transportation to operating according to the second mode of transportation. In some embodiments, the first electronic device detects the change in contextual information without detecting user input corresponding to a request to change from the first mode of transportation to the second mode of transportation.

In some embodiments, the first electronic device ceases (702e) to operate according to the first mode of transportation and operates (7020 according to the second mode of transportation such as transitioning from displaying driving navigation directions shown in FIG. 6C to displaying walking navigation directions shown in FIG. 6D. In some embodiments, while operating according to the second mode of transportation, the first electronic device displays (702g), via the display generation component, a second navigation user interface, such as the user interface shown in FIG. 6D, different from the first navigation user interface, such as the user interface shown in FIG. 6C, wherein the second navigation interface includes a second option for initiating navigation according to the second mode of transportation, different from the first option for initiating navigation according to the first mode of transportation. In some embodiments, the change from operating according to the first mode of transportation to operating according to the second mode of transportation causes the first electronic device to transition from displaying the first navigation user interface to displaying the second navigation user interface. In some embodiments, the change from operating according to the first mode of transportation to operating according to the second mode of transportation causes the first electronic device to transition from not displaying the first navigation presentation (e.g., first navigation instructions) while operating in the first mode of transportation to not displaying the first navigation presentation while operating in the second mode of transportation. In some embodiments, the change from operating according to the first mode of transportation to operating according to the second mode of transportation causes the first electronic device to transition from not displaying the first navigation user interface while operating in the first mode of transportation to displaying the first navigation user interface in the second mode of transportation. As used herein, the second navigation user interface optionally refers to a user interface of a mapping application. In some embodiments, the mapping application is installed and runs on the first electronic device and generates the second navigation user interface for display on the first electronic device. In some embodiments, the second navigation user interface is presented for display on a touch screen of a second electronic device such as a wearable device (e.g., watch). In some embodiments, the second navigation user interface is simultaneously displayed on both the first electronic device and the second electronic device. As used herein, the second navigation presentation optionally provides a set of navigation directions from a location of the first electronic device when the change in contextual information occurs, different from the first location, to the second location or another location associated with the specified destination (e.g., an ending location that was specified prior to the change in contextual information being detected). In some embodiments, the another location is accessible by the second mode of transportation and not the first mode of transportation. As used herein, the second mode of transportation optionally refers to walking. In some embodiments, the second option for initiating navigation according to the second mode of transportation includes user interface element, a visual appearance and/or layout based on the second mode of transportation. For example, when the second mode of transportation corresponds to the user walking, the second navigation user interface includes the second navigation presentation having a second mapping information, a second navigation information, and/or a second set of features. For example, the second mapping information optionally includes paved paths such as sidewalks, neighborhood details, building information, and/or bicycle or scooter rental information. In some embodiments, the second navigation information includes step-by-step walking guidance and/or an updated (e.g., different) estimated time of arrival to the specified destination based on the second mode of transportation. In some embodiments, the second set of features include presenting immersive (e.g., augmented reality) walking directions, presenting personalized walking guides, and/or presenting indoor maps or trail/park maps.

In some embodiments, in accordance with a determination that the one or more criteria are not satisfied, the first electronic device continues (702h) to operate according to the first mode of transportation, such as the driving mode of transportation as indicated by legend 626 in FIG. 6C. In some embodiments, continuing to operate in the first mode of transportation includes continuing to display, via the display generation component, the first navigation user interface including the first option for initiating navigation according to the first mode of transportation. For example, if the amount of change between the first speed and the second speed is less than the first threshold amount, the amount of change optionally does not indicate the start of the second mode of transportation or any other mode of transportation different from the first mode of transportation. In some embodiments, one or more second criteria are satisfied instead of the one or more criteria as will be described in more detail with reference to method 700. Automatically displaying the second navigation user interface having the second option for initiating navigation according to the second mode of transportation in response to the change in contextual information indicative of the start of the second mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first option for initiating navigation according to the first mode of transportation includes first navigation instructions from a first location to a second location, such as using the walking mode of transportation for initiating navigation from the location of the first electronic device 500a when the change in contextual information was detected to the destination as shown in content element 638b in FIG. 6D and the second option for initiating navigation according to the second mode of transportation includes second navigation instructions from a third location to the second location, such as using the biking mode of transportation for initiating navigation from the location of the first electronic device 500a when the change in contextual information was detected to the destination as shown in content element 638b in FIG. 6D which is the same destination, for example. In some embodiments, the first navigation instructions correspond to the set of navigation directions from the first location to the second location described above. In some embodiments, the second navigation instructions correspond to the set of navigation directions from the location of the first electronic device when the change in contextual information occurs as described above. In some embodiments, the second location included in the second navigation instructions is the same second location included in the first navigation instructions, prior to the change in contextual information occurring. Automatically displaying second navigation instructions for the second mode of transportation to the same location avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first option for initiating navigation according to the first mode of transportation includes first navigation instructions from a first location to a second location, such as using driving mode of transportation for initiating navigation from the current location 624 of the first electronic device 500a in FIG. 6C to a destination as shown in content element 638b in FIG. 6D and the second option for initiating navigation according to the second mode of transportation includes second navigation instructions from a third location to a fourth location, the third location different from the first location, such as using walking mode of transportation for initiating navigation from the location of the first electronic device 500a when the change in contextual information was detected to the destination as shown in content element 638b in FIG. 6D. As used herein, the second navigation presentation optionally provides second navigation directions from the third location (e.g., a location of the first electronic device when the change in contextual information occurs, different from the first location, to the fourth location associated with the specified destination (e.g., an ending location that was specified prior to the change in contextual information being detected). In some embodiments, the first location is a starting location and the second location is an ending location using the first mode of transportation. In some embodiments, when the first electronic device detects the change in contextual information, the first electronic device computes a route using the second mode of transportation. In some embodiments, the computed route using the second mode of transportation includes the second navigation instructions that guides the user using the second mode of transportation from another starting location (e.g., third location) different from the starting location (e.g., first location) using the first mode of transportation. In some embodiments, the third location is a current location of the first electronic device at the time of the contextual change. In some embodiments, the fourth location is the same as the second location. In some embodiments, the fourth location is different from the second location. In some embodiments, the first electronic device identifies one or more variations (e.g., recommendations to make navigating along the route or to the specified destination easier, more efficient, or to view sights or locations of interest) based on the mode of transportation. For example, when the second mode of transportation corresponds to a motorized vehicle, the fourth location proposed or recommended by the first electronic device is optionally a parking garage with an electronic vehicle charging station in proximity to the specified destination instead of the second location which corresponds to the street address of the specified destination. Automatically displaying second navigation instructions for the second mode of transportation from a location of the first electronic device when the change in contextual information is detected avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first navigation instructions include the first location in response to a first user input corresponding to a request to navigate from the first location such as from the current location 624 of the first electronic device 500a in FIG. 6C. In some embodiments, the first location is a current location of the first electronic device. In some embodiments, the first location is a user-specified location other than the current location of the first electronic device. In some embodiments, the second navigation instructions include the third location without receiving a second user input corresponding to a request to navigate from the third location such as the location of the first electronic device 500a when the change in contextual information was detected as shown in content element 638b in FIG. 6D. In some embodiments, the first electronic device displays the first navigation instructions in response to the first user input (e.g., in response to interaction with the navigation user interface). In some embodiments, the first electronic device presents the second navigation instructions independent of or not in response to interaction with the navigation user interface. As described above, in some embodiments, the first electronic device operates according to the second mode of transportation in accordance with the one or more criteria being satisfied. In some embodiments, the one or more criteria being satisfied is independent from receiving an input corresponding to a request to operate according to the second mode of transportation. In some embodiments, the first electronic device transitions from operating according to the first mode of transportation to operating according to the second mode of transportation without receiving a user input corresponding to a request to operate according to the second mode of transportation. In some embodiments, the third location is the location of the first electronic device at the time at which the one or more criteria are satisfied. Automatically displaying second navigation instructions for the second mode of transportation from a location of the first electronic device when the change in contextual information is detected and without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, prior to operating according to the first mode of transportation or the second mode of transportation (and/or while navigation along a route is not occurring), the first electronic device (e.g., 500a) receives, via the one or more sensors, an input corresponding to a request to navigate to a first location, such as causing the first electronic device (e.g., 500a) to initiate a process for providing navigation instructions according to the first mode of transportation or the second mode of transportation. In some embodiments, the one or more sensors generate sensor input data related to the first electronic device's motion or acceleration that indicates an activity the user is engaged in, such as driving or riding in a motorized vehicle, biking, walking, or running. In some embodiments, the sensor input data represents an environmental or usage change of the first electronic device. The sensor input data optionally includes other types of data as will be described below. In some embodiments, the input received via the one or more sensors causes the first electronic device to initiate a process for providing navigation instructions from a current location of the first electronic device to the first location according to the first mode of transportation. In some embodiments, the input corresponding to the request to navigate to the first location is received by the first electronic device via one or more input devices (e.g., a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the first electronic device), a handheld device (e.g., external), and/or a controller (e.g., external, etc.), or a set-top box in communication one or more input devices (e.g., a remote control). For example, the first electronic device detects, via the one or more input devices, an input directed to the navigation user interface corresponding to a request to navigate to the first location.

In some embodiments, in response to the input corresponding to the request to navigate to the first location, the first electronic device operates according to the first mode of transportation, wherein operating according to the second mode of transportation includes operating according to the second mode of transportation for a remainder of a route to the first location, such as shown in the transition from operating according to the driving mode of transportation in FIG. 6C to operating according to the walking mode of transportation as shown in FIG. 6D without receiving user input to transition to the walking mode of transportation for the remainder of the route to the first location. For example, navigating along the route for the remainder of the route to the first location includes the first electronic device recalculating the remainder of the route yet to be traveled from a location of the first electronic device when the change in contextual information occurred to the first location using the second mode of transportation. In some embodiments, the first electronic device continues to monitor contextual information and/or route information (e.g., traffic and/or road conditions) for the remainder of the route and present recommendations to or automatically change the remainder of the route and/or operate according to another mode of transportation, different from the second mode of transportation. Automatically displaying second navigation instructions for the remainder of the route according to the second mode of transportation from a location of the first electronic device when the change in contextual information is detected and without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, prior to operating according to the first mode of transportation or the second mode of transportation (and/or while navigation along a route is not occurring), the first electronic device receives, via the one or more sensors, an input corresponding to a request to navigate to a first location. In some embodiments, the one or more sensors generate sensor input data as described below. In some embodiments, the input received via the one or more sensors causes the first electronic device to initiate a process for providing navigation instructions from a current location of the first electronic device to the first location according to the first mode of transportation. In some embodiments, the first electronic device detects, via the one or more input devices, an input directed to the navigation user interface corresponding to the request to navigate to the first location.

In some embodiments, in response to the input corresponding to the request to navigate to the first location, the first electronic device operates according to the first mode of transportation, wherein in accordance with a determination that one or more second criteria are satisfied, including a criterion that is satisfied when operating according to the second mode of transportation is for less than a remainder of a route to the first location. In some embodiments, the first electronic device ceases to operate according to the second mode of transportation and operates according to a third mode of transportation, different from the second mode of transportation, such as shown in FIG. 6H where operating according to the biking mode of transportation is not recommended for the remainder of the route and in response, the first electronic device 500a ceases to operating according to the second mode of transportation and instead operates according to a walking mode of transportation as shown in FIG. 6E. In some embodiments, the third mode of transportation is the same as the first mode of transportation. In some embodiments, the third mode of transportation is different from the first mode of transportation. In some embodiments, the one or more second criteria being satisfied is independent from receiving an input corresponding to a request to operate according to the third mode of transportation. In some embodiments, the first electronic device transitions from operating according to the second mode of transportation to operating according to the third mode of transportation without receiving a user input corresponding to a request to operate according to the third mode of transportation. In some embodiments, the first electronic device determines that operating according to the second mode of transportation is for less than the remainder of the route to the first location by analyzing the route to determine breaks in using the second mode of transportation. For example, when the second mode of transportation corresponds to a bicycle, the first electronic device determines some bicycles stop biking when there is no bike lane, when bicycles are not allowed (e.g., pedestrian only areas), or when there is a steep hill. Thus, in some embodiments, the first electronic device computes the break in using the second mode of transportation and presents operating according to the third mode of transportation. In some embodiments, the one or more second criteria include a criterion that is satisfied when the change in contextual information indicates a start of the third mode of transportation as described above. Automatically operating according to the third mode of transportation from a location of the first electronic device when operating according to the second mode of transportation is for less than the remainder of the route is determined and without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first electronic device (e.g., 500a) operates according to the third mode of transportation without receiving a first user input corresponding to a request to operate according to the third mode of transportation, such as shown in the transition from operating according to the walking mode of transportation in FIG. 6E to operating according to the biking mode of transportation in FIG. 6F without receiving input corresponding to operating according to the biking mode of transportation. In some embodiments, the first electronic device initiates operating according to the third mode of transportation independent of or not in response to interaction with the navigation user interface. In some embodiments, the first electronic device operates according to the third mode of transportation in accordance with the one or more second criteria being satisfied, as described above. Automatically operating according to the third mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, before operating according to the second mode of transportation, the first electronic device included operating according to a fourth mode of transportation, different from the third mode of transportation, for the remainder of the route such as shown in FIG. 6H where the first electronic device 500a is operating according to the biking of transportation as originally set until detecting an upcoming contextual change (e.g., environmental change) indicating, as shown by content 668, taking stairs. In response, the first electronic device 500a initiates navigation instructions for the walking mode of transportation which is different from the originally set mode of transportation of biking. In some embodiments, the fourth mode of transportation is the same as the first mode of transportation. In some embodiments, the fourth mode of transportation is different from the first mode of transportation. In some embodiments, the fourth mode of transportation is the same as the second mode of transportation. In some embodiments, the fourth mode of transportation is different from the second mode of transportation. In some embodiments, the first electronic device originally designated the fourth mode of transportation for the route prior to ceasing to operate according to the second mode of transportation. In some embodiments, the fourth mode of transportation is automatically selected by the first electronic device in accordance with a determination that one or more criteria are satisfied as described above. For example, the first electronic device optionally did not receive user input corresponding to the request to operate according to the fourth mode of transportation. In some embodiments, the first electronic device is configured to prompt the user to accept the third mode of transportation for the remainder of the route if navigation according to the fourth mode of transportation has begun as will be described below. Automatically canceling plans to operate according to the fourth mode of transportation and instead initiate operation according to the third mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the contextual information includes a number of steps taken in a predefined time duration by a user associated with the first electronic device, such as in FIG. 6B illustrating pedometer device 612. In some embodiments, the first electronic device utilizes a built-in pedometer or step-counter to determine the mode of transportation. For example, the pedometer counts the number of steps traveled by the user in the predefined time duration (e.g., 3 seconds, 5, seconds, 10 seconds, 15 seconds, 20 seconds, 30 seconds, 40 seconds, 60 seconds, or 2 minutes) and, in turn, the first electronic device compares the number of steps to a prescribed threshold and determines the user's movement as one of walking, biking, riding in a motorized vehicle, or riding in public transportation. In some embodiments, the user's movement is detected with a pedometer, but other types of sensors as will be described below are utilized. For example, in accordance with a determination that the user's rate of steps increases from a rate that corresponds to not walking to a rate that corresponds to walking, the first electronic device transitions to providing walking navigation directions. Utilizing an ultra-low battery consuming device such as a pedometer to determine the mode of transportation without receiving user input avoids additional interaction between the user and the first electronic device associated with inputting a change in the mode of transportation when seamless transition between transportation modes is desired, thereby reducing errors in the interaction between the user and the first electronic device, reducing inputs needed to correct such errors, and reducing battery life needed to interact with a variety of user interfaces.

In some embodiments, the first electronic device detects the change in contextual information in accordance with a determination that the number of steps taken in the predefined time duration satisfies one or more second criteria, such as in FIG. 6A illustrating block 606. For example, the one or more second criteria include a criterion that is satisfied when the number of steps taken in the predefined time duration increases or decreases more than a predetermined amount (e.g., 15, 30, 50, 75, 100, 125, 150, 200, 250, 300, or 500 steps). In some embodiments, the first electronic device computes a correlation between the number of steps and second contextual information, such as in FIG. 6A illustrating block 604. In some embodiments, the first electronic device compares the correlation between the number of steps and the second contextual information and a predefined threshold, such as in FIG. 6A illustrating block 606. In some embodiments, the second contextual information includes GPS data, motion data, altitude information, position information, rotation rate, acceleration data measured by motion sensors (e.g., accelerometer and/or gyroscope), information related to whether the first electronic device is connected or disconnected from Bluetooth (e.g., for using an in-car user interface display or a wearable device such as a watch), location information from third party applications (e.g., rideshare, bicycle/scooter rentals, or social media). In some embodiments, the first electronic device considers a correlation between the number of steps and the second contextual information and when the correlation is above the predefined threshold (e.g., confidence predefined threshold: 70, 73, 75, 77, 80, 83, 85, 87, 90, 93, 95, 97, or 100%), the determined mode of transportation is accepted and/or assigned a first confidence value. When the correlation is below the predefined threshold, the determined mode of transportation is optionally rejected and/or assigned a second confidence value that is lower than the first confidence value. In some embodiments, the determined mode of transportation with the first confidence value is presented by the first electronic device. Utilizing one or more other data points from one or more other sensors to determine the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first option for initiating navigation according to the first mode of transportation includes one or more first user interface elements interactable to access one or more first functions of the first electronic device, such as the immersive augmented reality 644 function shown in FIG. 6E. In some embodiments, the second option for initiating navigation according to the second mode of transportation does not include the one or more first user interface elements such as the immersive augmented reality 644 function shown in FIG. 6E not available for the driving mode of transportation, for example. In some embodiments, the second navigation presentation includes one or more second user interface elements not included in the first navigation presentation. In some embodiments, when the first mode of transportation corresponds to a motorized vehicle, the one or more first functions include an in-car user interface display, zooming in and out a map view, turn-by-turn directions, traffic conditions, and/or estimated travel time. In some embodiments, the second mode of transportation corresponding to walking does not include the one or more first functions associated with the first mode of transportation. For example, the second mode of transportation includes one or more second functions, different from the one or more first functions, such as immersive walking directions shown in augmented reality, three-dimensional map views, and/or step-by-step walking directions. In some embodiments, when the mode of transportation corresponds to bicycling, the one or more functions include ride elevation, information on whether segments of the route include bike lanes, information related to how busy a street is, information on whether there are stairs, steep hills, or bike racks along the route, and/or voice-guided bicycling directions. In some embodiments, when the mode of transportation corresponds to public transportation, the one or more functions include location(s) of transit stations, embarkation and disembarkation information, and/or real-time transit information including transit schedules, departure and arrival times, connection information, and outages. Automatically displaying the first option for initiating navigation according to the first mode of transportation having one or more first functions, different from functions associated with a mode of transportation different from the first mode of transportation (e.g., second mode of transportation) in response to the change in contextual information indicative of the start of the first mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the second option for initiating navigation according to the second mode of transportation includes second navigation instructions from a first location to a second location. In some embodiments, the first electronic device displays, via the display generation component, a representation of a layout of a space and one or more routes to the second location within the space. For example, the representation of the layout of the space includes specialized indoor maps edited to provide content specific to the space (e.g., shopping centers, museums, convention halls, entertainment venues, parks, amphitheaters, or festivals) including elements within the space (e.g., restrooms, parking, vehicle charging stations, concession stands, dining areas, information desks, or trailheads, entrances and exits, bicycle trails, or scenic points of interest). In some embodiments, the first electronic device identifies one or more variations (e.g., recommendations to make navigating along the route or to the second location easier, more efficient, or to view sights or locations of interest along the way) based on the content specific to the space and/or the mode of transportation. For example, when the second mode of transportation corresponds to walking, the second location within the space proposed or recommended by the first electronic device is optionally “mall entrance C” which is closer to the specified destination (e.g., particular store in the mall) instead of a location which corresponds to the street address of the particular store. In another example, when the second mode of transportation corresponds to biking, the second location within the space proposed or recommended by the first electronic device is optionally “bicycle trailhead blue” which is one of a few bicycle trails at the specified destination (e.g., national park) instead of a location which corresponds to the street address of the national park. In some embodiments, the first option for initiating navigation according to the first mode of transportation does not include displaying the representation of the layout of the space. In some embodiments, the first navigation presentation includes displaying a representation of the space that includes less detail than the representation of the layout of the space displayed as part of the second navigation presentation. Utilizing the representation of the layout of the space to determine a more precise second location according to the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first option for initiating navigation according to the first mode of transportation includes first navigation instructions from a first location to a second location. In some embodiments, while navigating along a route from the first location to the second location, the first electronic device displays an indication of the first electronic device transitioning from ceasing to operate according to the first mode of transportation to operating according to the second mode of transportation such as content 656c shown in FIG. 6F. In some embodiments, the indication of the change is presented prior to the first electronic device operating according to the second mode of transportation. In some embodiments, the indication includes a graphical image and/or text description describing the second mode of transportation. In some embodiments, the indication includes a prompt to the user to accept or decline ceasing to operate according to the first mode of transportation and instead, to operate according to the second mode of transportation. In some embodiments, the first electronic device automatically transitions to operating according to the second mode of transportation after a period of time (e.g., 5, 10, 15, 20, 25, 30, 35, or 40 seconds). Automatically displaying an indication that the first electronic device will transition to operating according to the second mode of transportation from a location of the first electronic device when the change in contextual information is detected and without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors by providing improved visual feedback to the user.

In some embodiments, while operating according to the first mode of transportation, in accordance with a determination that an upcoming route characteristic satisfies one or more second criteria, such as a route characteristic that includes taking stairs as shown in FIG. 6H, in accordance with a determination that the upcoming route characteristic does not satisfy the one or more second criteria, the first electronic device operates according to the first mode of transportation without displaying the plurality of options for initiating navigation according to the plurality of respective modes of transportation, different from the second mode of transportation, such as when operating according to the walking mode of transportation, the first electronic device does not present other modes of transportation other than walking because the user may navigate the stairs using the walking mode of transportation. For example, the one or more second criteria include a criterion that is satisfied when the upcoming route characteristic relates to traffic, transit times, rental bicycle or scooter availability, path accessibility, user preferences (e.g., avoid hills, avoid tolls, etc.) indicative of ceasing to operate according to the first mode of transportation. In some embodiments, while operating according to the first mode of transportation, displaying, via the display generation component, a plurality of options for initiating navigation according to a plurality of respective modes of transportation (e.g., including the second mode of transportation), different from the first mode of transportation. In some embodiments, the first electronic device optionally presents for display the options for initiating navigation according to the plurality of respective modes of transportation from a location of the first electronic device within a predetermined distance (e.g., 3, 5, 7, 10, 13, 15, 17, 20 or 25 miles) from the upcoming route characteristic satisfying the one or more second criteria. As used herein, the first mode of transportation optionally refers to biking. In some embodiments, the first electronic device presents the walking mode of transportation in response to the determination that the upcoming route characteristic (e.g., steep hill) is along the route while operating according to the bicycle mode of transportation. In some embodiments, continuing to operate in the first mode of transportation includes continuing to display, via the display generation component, the first navigation user interface including the first option for initiating navigation according to the first mode of transportation. For example, if the upcoming route characteristic relates to a moderate hill, the upcoming route characteristic does not indicate presenting alternative modes of transportation (e.g., the plurality of options for initiating navigation according to the plurality for respective modes of transportation), different from the first mode of transportation. Automatically displaying the plurality of options for initiating navigation according to the plurality of respective modes of transportation in response to the upcoming route characteristic indicative of ceasing to operate according to the first mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, while operating according to the first mode of transportation, in accordance with a determination that an upcoming route characteristic satisfies one or more second criteria, such as a route characteristic that includes taking stairs as shown in FIG. 6H, while operating according to the first mode of transportation, the first electronic device detects, via the one or more sensors, a second change in contextual information, such as in addition to detecting that the first electronic device has disconnected from the second electronic device in FIG. 6C, the first electronic device detects a increased heart rate of the user which may indicate activity such as walking. For example, the first electronic device detects a change in contextual information as described above. In some embodiments, the second change in contextual information corresponds to a change in the physiological characteristic (e.g., heart rate, temperature, and/or respiratory rate) of the user captured or detected by the first electronic device and/or a second electronic device such as a wearable device (e.g., watch). In some embodiments, in response to detecting the second change (e.g., 604) in contextual information, such as in FIG. 6A, in accordance with a determination that the one or more criteria are satisfied, including a second criterion that is satisfied when the second change in contextual information indicates a start of a mode of transportation different from the first mode of transportation, such as movement of the first electronic device indicative of walking, while operating according to the first mode of transportation, first electronic device (e.g., 500a) displays, via the display generation component, a plurality of options for initiating navigation according to a plurality of respective modes of transportation, different from the second mode of transportation, such as walking navigation directions displayed on the first electronic device in FIG. 6D. For example, if the change in physiological characteristic corresponds to high cardiovascular fatigue, the change in physiological characteristic optionally indicates ceasing to operate according to the second mode of transportation (e.g., biking), and instead present or recommend to the user one or more modes of transportation (e.g., walking or taking public transit) different from the second mode of transportation. In some embodiments, the first electronic device automatically transitions from operating according to the first mode of transportation to operating according to the mode of transportation, different from the first mode of transportation in response to the one or more criteria being satisfied. For example, as a result of the user not experiencing high cardiovascular fatigue, the user changes from riding public transit to biking to which the first electronic device optionally ceases operating according to the public transit mode of transportation to the biking mode of transportation. In some embodiments, the first electronic device optionally presents for display the options from a location of the first electronic device when the second change in contextual information occurs. As used herein, the first mode of transportation optionally refers to biking. In some embodiments, the first electronic device presents the walking mode of transportation in response to the determination that the second change in contextual information indicates the start of the mode of transportation different from the first mode of transportation while operating according to the bicycle mode of transportation.

In some embodiments, in accordance with a determination (e.g., 606) that the one or more criteria are not satisfied, such as in FIG. 6A, the first electronic device (e.g., 500a) continues to operate according to the second mode of transportation without displaying the plurality of options for initiating navigation according to the plurality of respective modes of transportation, different from the second mode of transportation, such as continuing to present navigation instructions for the driving mode of transportation as shown in FIG. 6C when the movement of the first electronic device (e.g., 500a) is determined to be minimal and not enough to indicate initiating navigation according to a mode of transportation different from driving. In some embodiments, continuing to operate in the first mode of transportation includes continuing to display, via the display generation component, the first navigation user interface including the first option for initiating navigation according to the first mode of transportation. For example, if second change in contextual information corresponds to no cardiovascular fatigue, the first electronic device optionally does not present or suggest or operate according to alternative modes of transportation (e.g., the plurality of options for initiating navigation according to the plurality for respective modes of transportation), different from the second mode of transportation. Automatically displaying the plurality of options for initiating navigation according to the plurality of respective modes of transportation in response to the second change in contextual information indicative of ceasing to operate according to the first mode of transportation avoids additional interaction between the user and the first electronic device associated with inputting a change in the mode of transportation when seamless transition between transportation modes is desired, thereby reducing errors in the interaction between the user and the first electronic device, reducing inputs needed to correct such errors, and avoidable user injury.

In some embodiments, the plurality of options for initiating navigation according to the plurality of respective modes of transportation include respective estimated time for arriving at the second location such as information 666 shown in FIG. 6G. For example, the first electronic device optionally displays a navigation user interface element that includes an estimated time of arrival for arriving at the second location using a respective mode of transportation of the plurality of respective modes of transportation. In some embodiments, the respective modes of transportation are listed in an order based on soonest arrival time at the second location. In some embodiments, a recommended mode transportation is listed first in the list. In some embodiments, the recommended mode of transportation is based on one or more characteristics related to traffic, transit times, rental bicycle or scooter availability, path accessibility, user preferences (e.g., avoid hills, avoid tolls, etc.). For example, the mode with the soonest estimated time of arrival is listed first in the user interface. Automatically displaying respective estimated times for arriving at the second location according to the plurality of options for initiating navigation according to the plurality of respective modes of transportation in response to the upcoming route characteristic indicative of ceasing to operate according to the first mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, prior to operating according to the first mode of transportation or the second mode of transportation (and/or while navigating along a route is not occurring), the first electronic device (e.g., 500a) receives, via one or more input devices, a sequence of inputs corresponding to a request to navigate to a first location using the first mode of transportation and the second mode of transportation, such as using public transit and biking. In some embodiments, in response to the sequence of inputs corresponding to the request to navigate to the first location using the first mode of transportation and the second mode of transportation, the first electronic device (e.g., 500a) operates according to the first mode of transportation for a first segment of a route to the first location, wherein operating according to the second mode of transportation includes operating according to the second mode of transportation for a second segment of the route to the first location such as using public transit for the first segment of the route and biking for the second segment of the route. In some embodiments, the user provides the sequence of inputs using the navigation user interface of the mapping application. In some embodiments, the user provides the sequence of inputs using a system user interface of the first electronic device (e.g., voice assistant). In some embodiments, the sequence of the one or more inputs is received before beginning to navigate along a route from a starting location for the route to first location or during navigation. In some embodiments, the first segment of the route corresponds to first one or more directions to the first location using the first mode of transportation. In some embodiments, the second segment of the route corresponds to second one or more directions to the first location using the second mode of transportation. In some embodiments, the change from operating according to the first mode of transportation to operating according to the second mode of transportation causes the first electronic device to change navigation user interfaces as described above. In some embodiments, the first electronic device receives user input indicating the location of the first electronic device when operating according to the second mode of transportation for the second segment of the route to the first location begins. In some embodiments, the first electronic device presents one or more recommended second segments of the route to the first location using the second mode of transportation. In some embodiments, the one or more recommended second segments of the route to the first location using the second mode of transportation include a respective set of navigation directions from a respective location of the first electronic device when operating according to the second mode of transportation is predicted to occur. For example, the location optionally corresponds to a rideshare or taxi area of an airport, a bike rental pickup and drop-off areas, ferry or public transit stations. Providing means for the first electronic device to operate according to more than one mode of transportation to the same location avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first option for initiating navigation according to the first mode of transportation includes a first route from a first location to a second location. In some embodiments, the first navigation presenting further includes another route from a third location (e.g., a starting location of navigation) to the first location. In some embodiments, the first location is the location at which the first electronic device detects the change in contextual information. In some embodiments, the second option for initiating navigation according to the second mode of transportation includes a second route, different from the first route, from the first location to the second location, such as walking navigation directions include the first route from the current location of the first electronic device to a particular entrance accessible by foot as shown by content element 638b in FIG. 6D. In contrast the biking navigation directions shown in FIG. 6F include the second route from the current location of the first electronic device to a bike parking lot to park the user's bike. In some embodiments, the first electronic device optionally presents for display a plurality of options for initiating navigation including the first option and the second option using a respective route from the first location to the second location. In some embodiments, the second route using the second mode of transportation includes an estimated time of arrival to the second location sooner than the first route using the first mode of transportation. In some embodiments, the second route using the second mode of transportation includes an estimated time of arrival to the second location later than the first route using the first mode of transportation. In some embodiments, the first electronic device presents different route characteristics and/or display elements based on the mode of transportation as described above. Automatically displaying the plurality of options for initiating navigation according to the plurality of respective modes of transportation in response to the change in contextual information avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, such as in FIG. 6B, the contextual information includes detection of user exit from a motorized vehicle (e.g., 618) in communication with the first electronic device (e.g., 500a). In some embodiments, the contextual information corresponds to motion activity and the first electronic device determines when the first electronic device has entered and exited a car. For example, the first electronic device optionally determines the first electronic device has exited the motorized vehicle based on determining that the first electronic device has changed from a motionless state (e.g., placed in or on a device holder in the motorized vehicle) to an active state (e.g., change in position and/or movement caused by exiting the motorized vehicle). In some embodiments, the contextual information is based on one or more inputs other than motion activity (e.g., the first electronic device connection to the motorized vehicle computer). For example, absence of a Bluetooth connection to the motorized vehicle computer is optionally used as contextual information for exit determination. In some embodiments, the first electronic device is configured to present different navigation user interfaces based on the mode of transportation as described above. Detecting exit from the motorized vehicle to determine the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, such as in FIG. 6B, the contextual information includes detection of user entry into a motorized vehicle (e.g., 618) in communication with the first electronic device (e.g., 500a). For example, the first electronic device optionally determines the first electronic device has entered the motorized vehicle based on determining that the first electronic device has changed from the active state (e.g., change in position and/or movement caused by walking) to the motionless state (e.g., placed in or on a device holder in the motorized vehicle). In some embodiments, the contextual information is based on one or more inputs other than motion activity as described above. For example, a Bluetooth connection to the motorized vehicle computer is optionally used as contextual information for entry determination. In some embodiments, the first electronic device is configured to present different navigation user interfaces based on the mode of transportation as described above. Detecting entry into the motorized vehicle to determine the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, such as in FIG. 6B, the contextual information includes detection of one or more aspects of an external environment of a motorized vehicle (e.g., using sensor device(s) 616) in communication with the first electronic device (e.g., 500a). In some embodiments, the contextual information corresponds to a scenic environment, landmarks, points of interest, traffic, or weather captured by one or more motorized vehicle sensors such as a camera device to capture the external environment. For example, the first electronic device optionally determines the contextual information includes a sunrise or a sunset, and in response, the first electronic device optionally presents a navigation user interface including one or more routes using a walking mode of transportation to view the external environment. In some embodiments, the first electronic device is configured to present different navigation user interfaces based on the mode of transportation as described above. Detecting the one or more aspects of the external environment that may be of interest to the user to determine the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, such as in FIG. 6B, the contextual information includes detection of one or more characteristics of a user (e.g., using sensor device(s) 616 and/or pedometer device (e.g., 612) of the first electronic device (e.g., 500a). For example, the one or more characteristics of the user include one or more physiological characteristics described above. In some embodiments, the first electronic device detects a potentially concerning state of the user (e.g., drowsy, distracted, or stressed) while using the mode of transportation (e.g., walking, bicycling, or driving). For example, when the first electronic device detects whether the user is driving in the potentially concerning state based on information from the one or more sensors of the first electronic device, a second electronic device such as a wearable device (e.g., watch), and/or the motorized vehicle, the first electronic device, in response to the detection, is configured to cease operating according to the mode of operation when the one or more characteristics indicating the potentially concerning state of the user is detected, and instead, optionally operate according to another mode of transportation (e.g., walking), different from the mode of transportation. In some embodiments, the first electronic device is configured to present different navigation user interfaces based on the mode of transportation as described above. Detecting the one or more characteristics of the user of the first electronic device to determine the mode of transportation without receiving user input avoids additional interaction between the user and the first electronic device associated with inputting a change in the mode of transportation when seamless transition between transportation modes is desired, thereby reducing errors in the interaction between the user and the first electronic device, reducing inputs needed to correct such errors, and avoidable user injury.

In some embodiments, while operating according to the first mode of transportation, the first electronic device transmits to a second electronic device, different from the first electronic device, one or more instructions that cause the second electronic device to display the first navigation interface including the first option for initiating navigation according to the first mode of transportation such as the first electronic device 500a configured to stream or share navigation instructions for presentation on the second electronic device 500b as shown in FIG. 6C. In some embodiments, the first electronic device is configured to provide navigation data (e.g., route data and/or navigation directions) to one or more external devices (e.g., the second electronic device) or displays for presentation on the one or more external devices or displays. The one or more external devices or displays include watch devices, head-mounted devices, or motorized vehicle displays. In some embodiments, the first electronic device and the one or more external devices or displays are configured to present different navigation user interfaces based on the mode of transportation as described in above. Automatically displaying the first option for initiating navigation to the second electronic device in response to the change in contextual information avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, such as in FIG. 6A, while displaying the first navigation user interface, the first electronic device (e.g., 500a) detects, via the one or more sensors, a second change in contextual information (e.g., 604). For example, the first electronic device detects the second change in contextual information described above. In some embodiments, in response to detecting the second change in contextual information (e.g., 604), such as in FIG. 6A, in accordance with a determination that the one or more criteria are satisfied, including a second criterion that is satisfied when the first electronic device is in communication with a second electronic device, such as second electronic device 500b in FIG. 6C, that was not in communication with prior to the change in contextual information, the first electronic device (e.g., 500a) ceases to operate according to the first mode of transportation and operates according to a third mode of transportation (e.g., 608), such as in FIG. 6A, such as the driving mode of transportation indicated by legend 626 in FIG. 6A. For example, if the first electronic device transitions from being not in communication with the second electronic device (e.g., watch, head-mounted device, or motorized vehicle display device) to being in communication with the second electronic device, the transition optionally indicates ceasing to operate according to the first mode of transportation, and instead operate according to the third mode of transportation, different from the first mode of transportation. In some embodiments, the third mode of transportation is associated with the second electronic device in communication with the first electronic device. For example, when the electronic device is in communication with the motorized vehicle display device, the third mode of transportation optionally corresponds to driving. In some embodiments, the second electronic device corresponds to rideshare systems, rental bike or scooter systems, or public transit information systems. For example, when the electronic device is in communication with the public transit information systems, the third mode of transportation optionally corresponds to using public transportation. In some embodiments, detecting that the first electronic device is in communication with the second electronic device serves as confirmation for operating according to the third mode of transportation. Detecting whether or not the first electronic device is in communication with the second electronic device to determine the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, in accordance with a determination that a first set of modes of transportation are selected by a user of the first electronic device as available, the second mode of transportation is one of the first set of modes of transportation. For example, the modes of transportation the user wants or prefers to use constitute the first set of modes of transportation selected by the user. In some embodiments, each mode of transportation in the first set, corresponds to a different mode of transportation and is optionally characterized by one or more of parameters set by the user. For example, the one or more parameters include avoiding tolls, highways, biking on paths with no bike lanes, and/or walking in a direction against traffic. In some embodiments, in accordance with a determination that a second set of modes of transportation different form the first set of modes of transportation are selected by the user of the first electronic device as available, the second mode of transportation is one of the second set of modes of transportation. For example, the modes of transportation the user does not want to use constitute the second set of modes of transportation selected by the user. In some embodiments, the electronic device is not configured to operate according to the modes of transportation in the second set of modes of transportation. In some embodiments, the electronic device does not detect for contextual information related to the modes of transportation in the second set of modes of transportation. Detecting whether or not the second mode of transportation is listed in the first or second set of modes of transportation to determine the mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, while operating according to the first mode of transportation, the first electronic device detects, via the one or more sensors, second contextual information (e.g., 604), such as in FIG. 6A. For example, second contextual information is described above. In some embodiments, in response to detecting the second contextual information (e.g., 604), such as in FIG. 6A, in accordance with a determination that the one or more criteria are satisfied, including a second criterion that is satisfied when the second contextual information indicates a start of a third mode of transportation, different from the first mode of transportation, the first electronic device ceases to operate according to the first mode of transportation and operates according to the third mode of transportation (e.g., 608). For example, if an amount of change between a second speed of the electronic device using the first mode of transportation and a third speed is greater than the first threshold amount described above, the amount of change optionally indicates the start of the third mode of transportation. Other indications of starting (or initiating a start of) another mode of transportation (e.g., the third mode of transportation) as described above. In some embodiments, the first electronic device detects the change in contextual information without detecting user input. For example, detecting user input is not part of the determination that one or more criteria are satisfied, including a criterion that is satisfied when the change in contextual information indicates a change from operating according to the first mode of transportation to operating according to the third mode of transportation. In some embodiments, the first electronic device detects the change in contextual information without detecting user input corresponding to a request to change from the first mode of transportation to the third mode of transportation. In some embodiments, the first electronic device continues to monitor contextual information to automatically operate according to the third mode of transportation, different from the first mode of transportation. In some embodiments, the third mode of transportation corresponds to the second mode of transportation. In some embodiments, the third mode of transportation is different from second mode of transportation. Automatically operating according to the third mode of transportation in response to the change in contextual information indicative of the start of the third mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

It should be understood that the particular order in which the operations in FIG. 7 has been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 900) are also applicable in an analogous manner to method 700 described above with respect to FIG. 7. For example, the operation of the electronic device to change transportation modes in accordance with a change in contextual information described above with reference to method 700 optionally has one or more of the characteristics of the presentation of route planning user interfaces for planning routes with two or more modes of transportation described herein with reference to other methods described herein (e.g., method 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 is, optionally, implemented by components depicted in FIGS. 1A-1B. For example, detecting operation 702a, adding operation 702b, detecting operation 702c, and initiating operation 702e are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Adding a Destination Using a Particular Mode of Transportation in a Multiple Destination Route

Users interact with electronic devices in many different manners. The embodiments described below provide ways in which an electronic device facilitates adding a destination and specifying the mode of transportation for navigating to the added destination in a multiple destination route for navigation directions. Enhancing interactions with a device reduces the amount of time needed by a user to perform operations, and thus reduces the power usage of the device and increases battery life for battery-powered devices. The ability for an electronic device to add a destination using a particular mode of transportation to the route provides an efficient way of presenting information relevant to the mode of transportation, which reduces power usage and improves battery life of the electronic device by enabling the user to use the electronic device more quickly and efficiently. When a person uses a device, that person is optionally referred to as a user of the device.

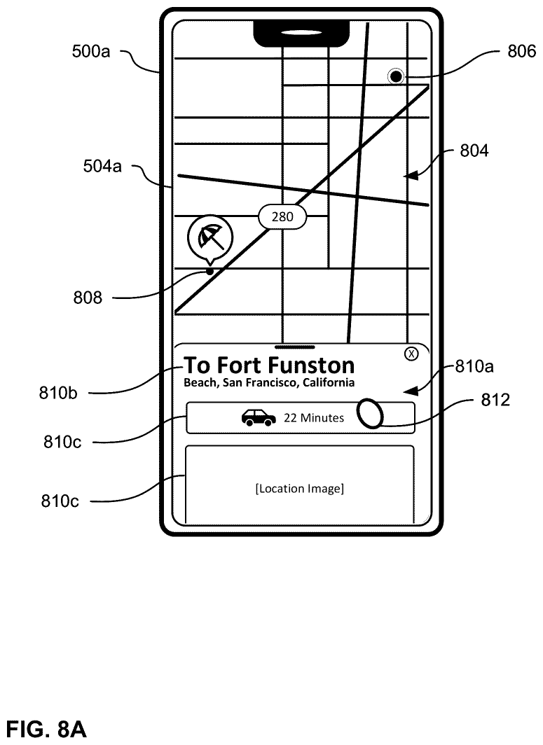

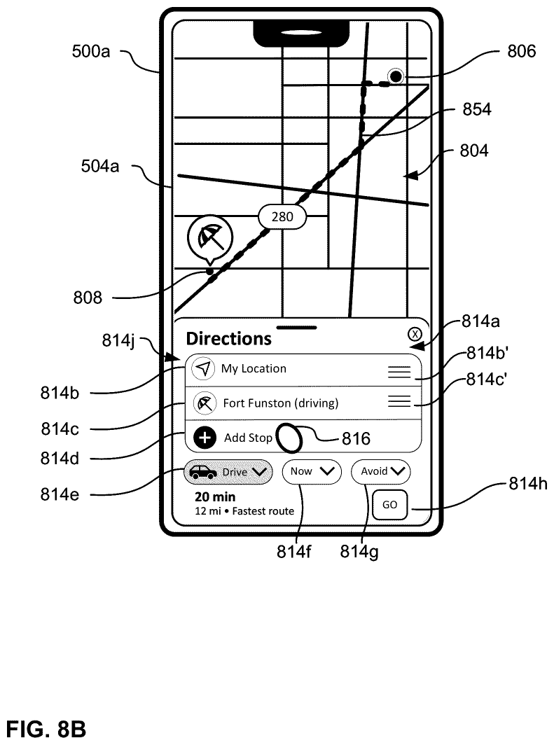

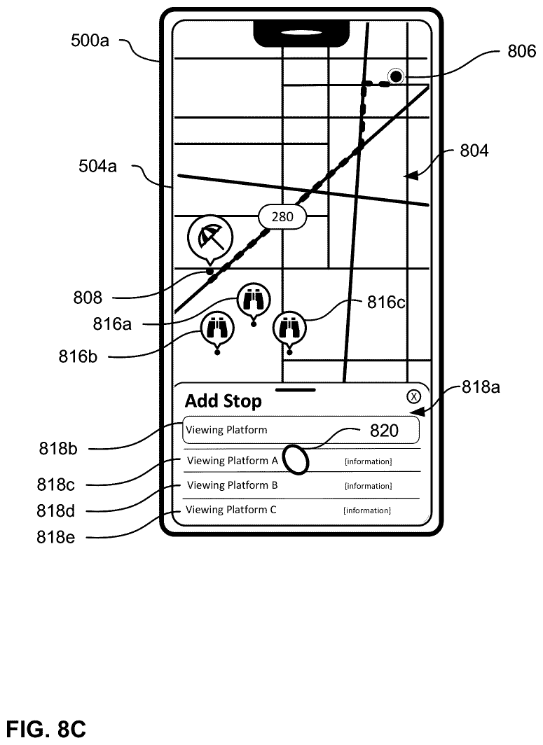

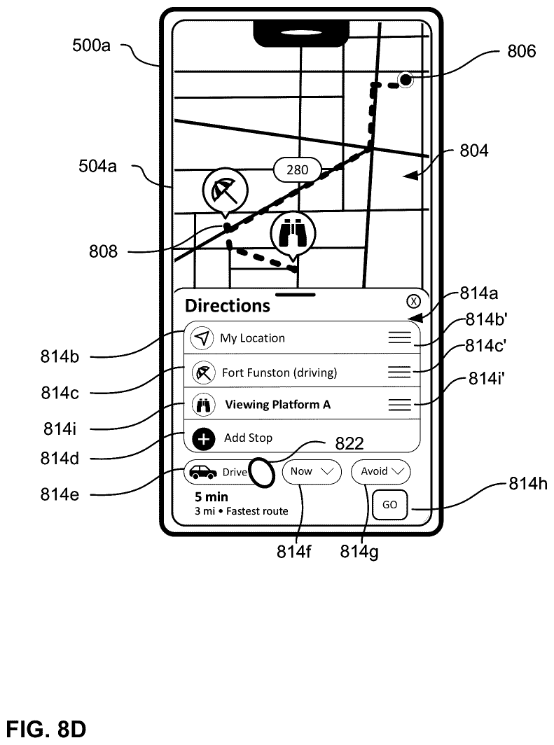

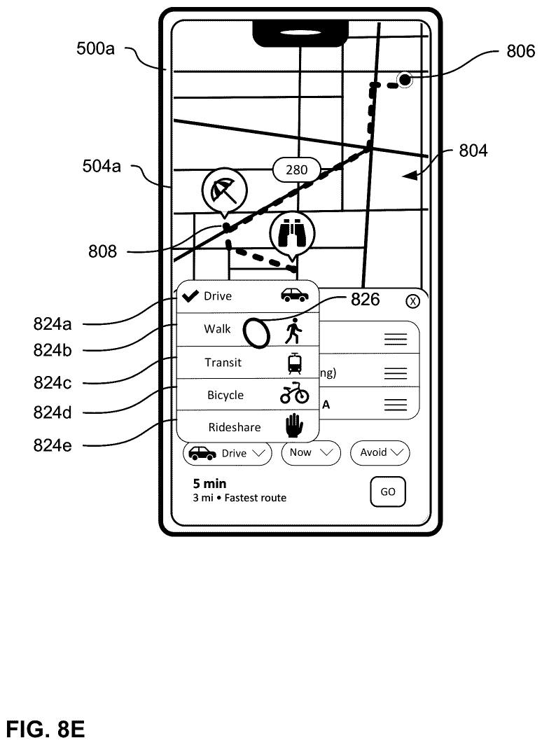

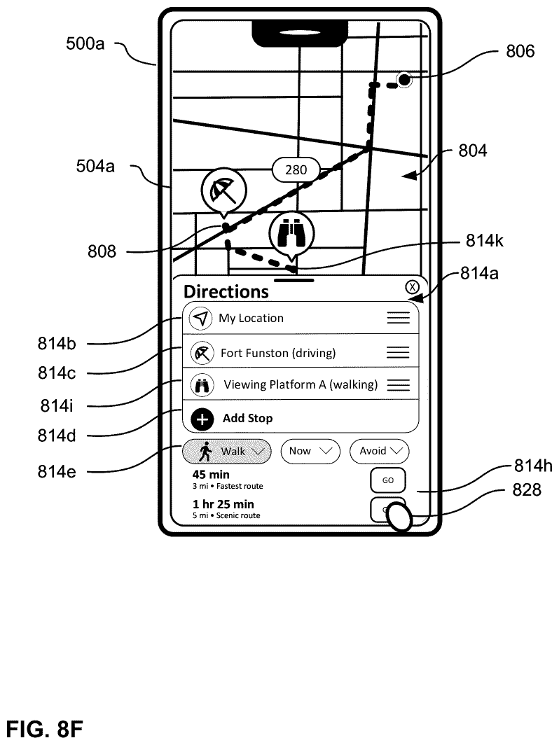

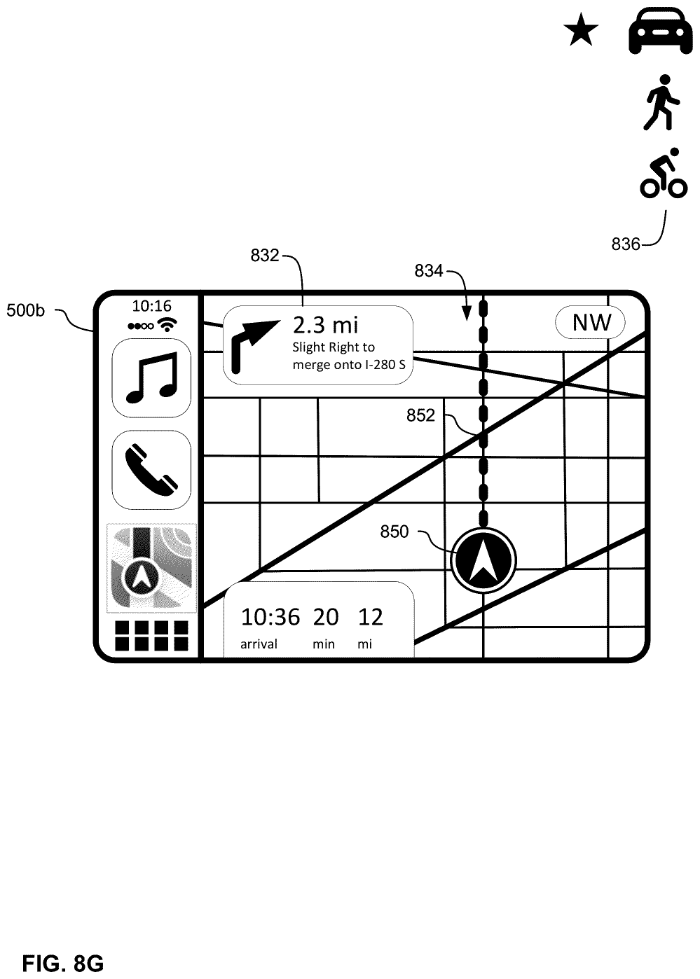

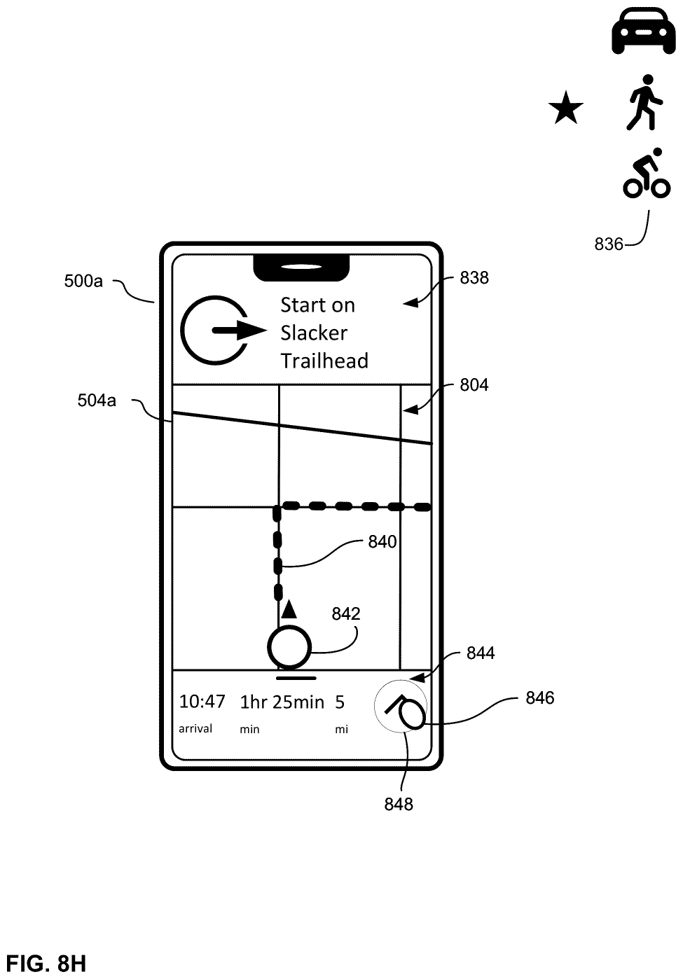

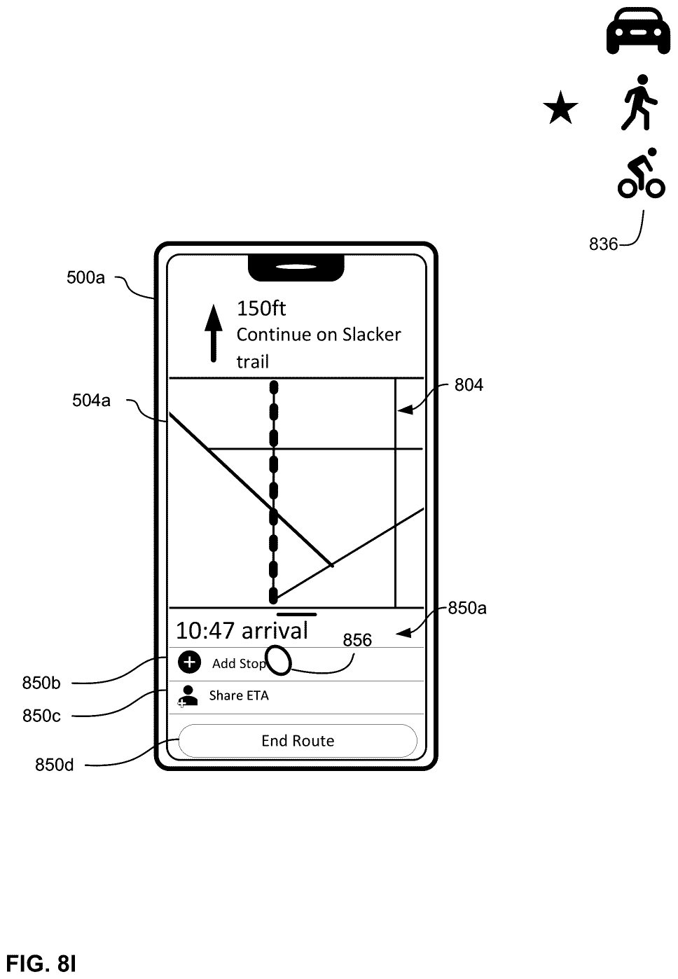

FIGS. 8A-8I illustrate exemplary ways of configuring a route with multiple destinations and multiple modes of transportation in accordance with some embodiments of the disclosure. The embodiments in these figures are used to illustrate the processes described below, including the processes described with reference to FIG. 9.

FIG. 8A illustrates an example of a first electronic device 500a that includes touch screen 504a displaying a route configuration user interface of a mapping application. In some embodiments, the user interface is for configuring a route from a start location to a destination location through a plurality of intermediate destinations and/or waypoints using a one or more modes of transportation (e.g., driving, walking, riding public transit, biking, and/or using rideshare). In FIG. 8A, for example, the route configuration user interface includes a map 804 including a representation of the current location 806 of the first electronic device 500a and a representation of the first destination 808. FIG. 8A also shows that, in some embodiments, the first electronic device 500a includes a user interface element 810a overlaid on map 804. In some embodiments, the user interface element 810a includes information related to navigating to the first destination according to a first mode of transportation (e.g., driving), such as content 810b which identifies the destination (e.g., “Fort Funston Beach”) and an image 810c of the destination. The user interface element also includes a selectable user interface element 810c that indicates the mode of transportation (e.g., driving) and the length of time (e.g., 22 minutes) to reach the first destination, for example. In some embodiments, in response to detecting selection of the selectable user interface element 810c, the first electronic device 500a initiates navigation instructions for traversing the route from the current location 806 of the first electronic device 500a to the first destination 808. In FIG. 8A, the electronic device 500a detects selection (e.g., with contact 812) of selectable user interface element 810c. In response, the electronic device 500a updates the route configuration user interface as shown in FIG. 8B to include an indication of the route 854 from the current location 806 of the first electronic device 500a and a representation of the first destination 808 on the map 804.

FIG. 8B illustrates an example of the electronic device 500a updating the user interface in response to the input illustrated in FIG. 8A. For example, the electronic device 500a updates the route configuration user interface to include user interface element 814a overlaid on map 804. In some embodiments, the user interface element 814a includes user interface element 814j, selectable user interface element 814e, selectable user interface element 814f, selectable user interface element 814g, and user interface element 814h. User interface element 814j optionally presents the route information organized in a list such as starting location content item 814b corresponding to the current location 806 of the electronic device and first destination content item 814c corresponding to the first destination 808. In some embodiments, the content items listed including the starting location content item 814b and the first destination content item include a corresponding selectable element (e.g., 814b′ and 814c′) that, when selected, causes the electronic device 500a to move its corresponding content item to rearrange or reorder the route. In some embodiments, user interface element 814j also includes selectable user interface element 814d, that, when selected, causes the first electronic device 500a to add a stop or destination to the route. In some embodiments, in response to detecting selectable user interface element 814e, the first electronic device 500a changes the mode of transportation for the navigation directions as will be described below. As shown in FIG. 8B, for example, user interface element 814e the mode of transportation is set to driving such that driving directions will be presented when navigating to the first destination 808 in response to detecting selection of selectable user interface element 814h. In some embodiments, in response to detecting selection of selectable user interface element 814f, the first electronic device 500a sets the time of departure from starting location. In some embodiments, in response to detecting selection of selectable user interface element 814g, the first electronic device 500a sets the user's preferences for the route such as avoiding tolls or highways when presenting driving directions or avoiding hills or busy roads when presenting cycling directions. In some embodiments, user interface element 814h includes content indicating the length of time (e.g., 22 minutes) to reach the first destination, the distance to the first destination, and that the route is the fastest. User interface element 814h also includes a selectable user interface element that, when selected, causes the first electronic device 500a to initiate navigation instructions for traversing the route, for example.

In some embodiments, the electronic device 500a adds a second destination to the route. For example, as shown in FIG. 8B, the user selects (e.g., with contact 816) selectable user interface element 814d selectable to add a destination to the route. In response, the first electronic device 500a updates the route configuration user interface as shown in FIG. 8C to include user interface element 818a which includes user interface element 818b that is interactable to enter a destination to be added to the route. As shown in FIG. 8C, the user entered (e.g., entered via keyboard or voice input) “Viewing Platform” to user interface element 818b which corresponds to a request to search for locations for the to-be added destination that are related to “Viewing Platform”. User interface element 818a also includes one or more results to the search request (e.g., 818c, 818d, and 818e) as shown in FIG. 8C. In some embodiments, as shown in FIG. 8C, the electronic device 500a updates the map 804 to include indications of the one or more results to the search request (e.g., 816a, 816b, and 816c). FIG. 8C also shows that the first electronic device 500a detects selection (e.g., with contact 820) of search result element 818c (“Viewing Platform A”), for example. In response, in some embodiments, the electronic device 500a updates the route configuration user interface as shown in FIG. 8D to include user interface element 814a which is similar to the route configuration user interface shown in FIG. 8B. However, the route configuration user interface as shown in FIG. 8D includes the selected result element 818c shown as the added, second destination in content item 814i, for example. Content item 814i also includes selectable element 814i′ that when selected causes the first electronic device 500a to move content item 814i to rearrange or reorder the route (e.g., set content item 814i as the first destination instead of the second destination). In some embodiments, when adding destinations to the route, the first electronic device 500a receives a request to add a segment to the route using a selected mode of transportation without the user specifying the destination to be added to the route. In some embodiments, the first electronic device 500a conducts a search based on the route and the selected mode of transportation and adds a destination in accordance with the search results to the route. In some embodiments, while the user is editing the route, the first electronic device 500a presents options for providing reservation and/or payment for modes of transportation used in the route, such as reserving a bicycle rental, purchasing a transit pass or ticket, and/or booking a rideshare service or calling a personal vehicle. In some implementations, a user can request to add a segment to the route and the first electronic device 500a may suggest alternative modes for navigating to the route.

FIG. 8D also shows that the user selects (e.g., with contact 822), selectable user interface element 814e selectable to change the mode of transportation, for example. In response, in some embodiments, the electronic device 500a updates the user interface as shown in FIG. 8E to include user interface element 824a corresponding to a first mode of transportation (e.g., driving), user interface element 824b corresponding to a second mode of transportation (e.g., walking), user interface element 824c corresponding to a third mode of transportation (e.g., riding public transit), user interface element 824d corresponding to a fourth mode of transportation (e.g., biking), and user interface element 824e corresponding to a fifth mode of transportation (e.g., using rideshare). As shown indicated in FIG. 8E, for example, the first mode of transportation (e.g., driving) is currently selected for the navigation route.

In some embodiments, as described with reference to method 700, the user may select two or more modes of transportation for the navigation route. In FIG. 8E, the user selects (e.g., with contact 826), user interface element 824b corresponding to a second mode of transportation (e.g., walking). In response to the input in FIG. 8E, in some embodiments, the first electronic device 500a updates the route configuration user interface as shown in FIG. 8F.

FIG. 8F illustrates an example of the first electronic device 500a displaying the user interface updated to include user interface element 814a which is similar to the route configuration user interface in FIG. 8E, in response to receiving the input illustrated in FIG. 8E. However, in some embodiments, the route configuration user interface as shown in FIG. 8F includes in content item 814i an indication of the second mode of transportation. In some embodiments, the first electronic device 500a also updates map 804 to indicate the second destination 814k. In some embodiments, if the first electronic device 500a were to receive selection of option 814d, the first electronic device 500a would display a user interface similar to the user interface in FIG. 8C for adding an additional destination to the route. In some embodiments, when adding an additional destination after the second destination, the first electronic device 500a conducts a search for the additional destination based on the location of the second destination. In some embodiments, when adding an additional destination after the first destination, the first electronic device 500a conducts the search for the additional destination based on the location of the first destination. In some embodiments, the first electronic device 500a is able to conduct a search for facilities and locations related to transportation, such as bike racks, electric vehicle charging stations, and/or parking lots. The electronic device 500a also updates, as shown in FIG. 8F, user interface element 814h to include two different route options which each include content indicating the length of time to reach the second destination using the second mode of transportation, the distance to the second destination, and a route identifier (e.g., fastest route, scenic route, or eco-friendly), for example. In some embodiments, the route options use the mode of transportation selected by the user. In some embodiments, the route options include one or more options using modes of transportation other than the mode of transportation selected by the user. In some embodiments, the routes are based on user-selected settings, such as avoiding tolls or highways for driving or avoiding hills or roads without bike lanes for cycling. In some embodiments, the route options of user interface element 814h also include respective selectable user interface elements selectable to initiate navigation instructions for traversing the respective route.

As shown in FIG. 8F, the user selects (e.g., with contact 822) one of the route options listed in user interface element 814h, for example. In response to the input illustrated in FIG. 8F, the electronic device 500a initiates navigation instructions for traversing the route, as shown in FIG. 8G. In some embodiments, as shown in FIG. 8G, the electronic device 500a is in communication with motorized vehicle display 500b and is configured by electronic device 500a to display the maps application user interface which includes navigation instructions for traversing the route to the first destination using the first mode of transportation (e.g., driving) as also indicated by legend 836, for example.

As shown in FIG. 8G, the maps application user interface includes a map 834 including a representation of the current location 850 of the first electronic device 500a and an indication of the route 852. As shown in FIG. 8G, in some embodiments, the maps application user interface includes content 832 representing the next maneuver of the navigation directions to be performed according to the first mode of transportation which includes an indication of the distance between the current location of the first electronic device 500a and the location of the maneuver, an image representing the maneuver to be performed, and text describing the maneuver to be performed. In some embodiments, the first electronic device 500a displays the navigation directions in the navigation user interface.

In some embodiments, the first electronic device 500a continues navigating along the route configured in the previous figures. In some embodiments, the first electronic device 500a reaches the first destination in the multi-destination route. In some embodiments, the route continues with a different mode of transportation.

As shown in FIG. 8H, for example, the electronic device 500a displays maps application user interface navigating from the first destination to the second destination using the second mode of transportation (e.g., walking) as also indicated by legend 836. FIG. 8H also shows content 838 representing the next maneuver of the navigation directions to be performed according to the second mode of transportation in some embodiments. In some embodiments, the content 838 includes an indication of the distance between the current location of the first electronic device 500a and the location of the upcoming maneuver, an image representing the maneuver to be performed, and text describing the maneuver to be performed. While navigating according to the second mode of transportation, the first electronic device 500a includes information related to an estimated time of arrival 844 as shown in FIG. 8H, for example. In some embodiments, upon reaching the first destination, the first electronic device 500a displays a notification of the change in transportation methods from the first transportation method (e.g., driving) to the second transportation method (e.g., walking).

In some embodiments, the maps application user interface also includes selectable user interface element 848 that, when selected, causes the first electronic device 500a to configure the route or share the route as shown in FIG. 8H. In some embodiments, the electronic device 500a detects selection (e.g., with contact 846) of selectable user interface element 848 as shown in FIG. 8H. In response to the input in FIG. 8H, as shown in FIG. 8I, the electronic device 500a updates the maps application user interface to include user interface element 850a. User interface element 850a optionally includes selectable user interface element 850b that, when selected, causes the electronic device 500a to add a stop to the route. In some embodiments, user interface element 850a also includes selectable user interface element 850c that, when selected, causes the first electronic device 500a to share the route to a second electronic device other than the first electronic device 500. Examples of sharing the route with the second electronic device are described in more detail with reference to method 900. As shown in FIG. 8I, the user selects (e.g., with contact 856) selectable user interface element 850b. In response to the input in FIG. 8I, the electronic device 500a displays the route configuration user interface similar to the route configuration user interface shown in FIG. 8F.

FIG. 9 is a flow diagram illustrating a method 900 of configuring a route with multiple destinations and multiple modes of transportation in accordance with some embodiments of the disclosure, such as in FIGS. 8A-8I. The method 900 is optionally performed at an electronic device such as device 100, device 300, or device 500 as described above with reference to FIGS. 1A-1B, 2-3, 4A-4B and 5A-5H. In some embodiments, method 900 is performed at or by an automobile (e.g., at an infotainment system of an automobile having or in communication with one or more display generation components and/or input devices). Some operations in method 900 are, optionally combined and/or order of some operations is, optionally, changed.

As described below, the method 900 provides ways to configure a route with multiple destinations and multiple modes of transportation. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed at a first electronic device (e.g., 500a) in communication with a display generation component (e.g., 504) and one or more sensors. For example, the first electronic device includes devices described with reference to method 700. In some embodiments, the display generation component includes a display as described with reference to method 700. In some embodiments, the one or more input devices include input devices as described with reference to method 800.

In some embodiments, while displaying, via the display generation component, a route configuration user interface, such as user interface element 814a in FIG. 8B, the computer system detects, via the one or more input devices, a first user input corresponding to a request to add a first destination to a route using a first mode of transportation (902a), such as the user selecting with contact 826 user interface element 824b in FIG. 8F. In some embodiments, the route configuration user interface is a user interface of the mapping application described with reference to method 700. In some embodiments, the route configuration user interface is interactable for initiating a process to configure a route from a first location (e.g., location of the first electronic device when navigation directions were requested or specified location inputted by the user via the first navigation user interface) to the first destination. In some embodiments, the electronic device presents one or more routes to the first destination using the first mode of transportation. The one or more routes optionally include respective turn-by-turn directions to the first destination. In some embodiments, the electronic device changes the one or more routes to a second one or more routes, different from the one or more routes, to the first destination based on the mode of transportation. In some embodiments, the route configuration user interface includes options for selecting a departure time from the first location and/or an arrival time at the first destination, avoiding traffic, choosing a means for public transit (e.g., bus, underground train, above ground train, ferry, or trolley), and/or other route options as described with reference to methods 700 and/or 900. In some embodiments, the electronic device presents, via the route configuration user interface, the first mode of transportation and/or one or more other modes of transportation for selection by the user to be used for providing navigation directions from the first location to the first destination. The first mode of transportation optionally corresponds to driving, biking, walking, using public transit, using a rideshare, or using a motorized vehicle for hire (e.g., taxi service). In some embodiments, the modes of transportation are presented as an ordered list as will be described with reference to methods 700 and/or 900. In some embodiments, the electronic device automatically selects the mode of transportation for presentation to the user via the route configuration user interface based on fastest route, user preference, and/or contextual information as described with reference to method 700.

In some embodiments, in response to detecting the first user input, the first electronic device adds the first destination using the first mode of transportation to the route (902b), such as shown by content item 814i in FIG. 8G. In some embodiments, the first destination using the first mode of transportation is optionally added to the route by the user searching within the route configuration user interface (e.g., searching for a destination using the first mode of transportation, and selecting a selectable option associated with a destination displayed in response to the search to generate and/or displaying a navigation route from the first location to the first destination using the first mode of transportation). In some embodiments, the first destination using the first mode of transportation is optionally entered manually by the user.

In some embodiments, the first electronic device (e.g., 500a) detects (902c), via the one or more input devices, a second user input corresponding to a request to add a second destination to the route using a second mode of transportation, different from the first mode of transportation, such as the user selecting with contact 856 selectable user interface element 850b in FIG. 8I. In some embodiments, and prior to the electronic device finalizing the route and/or initiating navigation instructions for traversing the route, the route configuration user interface receives a second user input that corresponds to a request to search for the second destination to be added to the route using the second mode of transportation. For example, the user optionally provides input to add a point of interest (e.g., cafe stop, public restroom, scenic view, or landmark) to the route after the first destination on the route. Accordingly, the electronic device optionally receives input corresponding to the request to search for the point of interest. In some embodiments, the first mode of transportation corresponds to driving and the second mode of transportation corresponds to a mode of transportation other than driving (e.g., biking, walking, using public transit, using a rideshare, or using a motorized vehicle for hire (e.g., taxi service)).

In some embodiments, in response to detecting the second user input, the first electronic device adds the second destination using the second mode of transportation to the route (902d), such as adding content item 814c corresponding to a destination using a driving mode of transportation, different from the mode of transportation for content item 814i in FIG. 8G. In some embodiments, the route includes navigation directions using the first mode of transportation from the first location to the first destination, and navigation directions using the second mode of transportation from the first destination to the second destination. In some embodiments, the second destination using the second mode of transportation is added after the first destination in the route. In some embodiments, the second destination using the second of transportation is added before the first destination in the route. Adding a destination using a particular mode of transportation to the route provides an efficient way of presenting information relevant to the mode of transportation, which reduces power usage and improves battery life of the electronic device by enabling the user to use the electronic device more quickly and efficiently.

In some embodiments, while a respective destination using a respective mode of transportation is included in the route, the first electronic device displays, via the display generation component, a plurality of selectable options for selecting a plurality of suggested routes using other modes of transportation, different from the respective mode of transportation, for navigating to the respective destination, such as one or more routes 814h included in FIG. 8F using forms of transportation other than walking. In some embodiments, and prior to the electronic device finalizing the route and/or initiating navigation instructions for traversing the route, the first electronic device displays the route configuration user interface including the plurality of selectable options for selecting a plurality of suggested routes using other modes of transportation, different from the respective mode of transportation, for navigating to the respective destination. In some embodiments, the plurality of suggested routes using other modes of transportation, different from the respective mode of transportation is based on contextual information described with reference to method 700. In some embodiments, the plurality of suggested routes using other modes of transportation, different from the respective mode of transportation is based on transportation preferences described below. In some embodiments, the plurality of suggested routes using other modes of transportation, different from the respective mode of transportation is based on whether a respective mode of transportation was recently used (e.g., by suggesting modes of transportation that were recently used by the first electronic device (e.g., in the past 5, 10, 15, 20, 30, 40, 50, or 60 minutes)). In some embodiments, the plurality of suggested routes using other modes of transportation, different from the respective mode of transportation is based on frequency with which the other modes of transportation are used by the user (e.g., by suggesting modes of transportation that are frequently used and/or requested by the user). In some embodiments, the first electronic device displays the route configuration user interface including the plurality of selectable options for selecting a plurality of suggested routes using the same mode of transportation as the respective mode of transportation. In some embodiments, the first electronic device displays the route configuration user interface including the plurality of selectable options for selecting a plurality of suggested routes using a plurality (e.g., at least two) different modes of transportation per route (e.g., walking and biking; or driving and walking; or walking and using public transit). In some embodiments, the plurality of selectable options include an option corresponding to a single other mode of transportation. In some embodiments, the plurality of suggested routes using includes route information for the particular mode of transportation (e.g., travel length, estimated time of arrival information, incline information, fare amounts, and/or public transit connection information). Providing a plurality of selectable options for selecting a plurality of suggested routes using other modes of transportation enhances interactions with the first electronic device (e.g., by reducing the amount of time needed for the user of the electronic device to perform route configuration operations), which reduces power usage and improves battery life of the electronic device by enabling the user to use the electronic device more quickly and efficiently.

In some embodiments, in accordance with a determination that a first set of transportation preferences are selected by a user of the first electronic device, such as preferences that may be set via selectable user interface element 814g in FIG. 8E, the plurality of suggested routes comply with the first set of transportation preferences. In some embodiments, in accordance with a determination that a second set of transportation preferences different from the first set of transportation preferences are selected by a user of the first electronic device, the plurality of suggested routes comply with the second set of transportation preferences. In some embodiments, the first set of transportation preferences and second set of transportation preferences correspond to the same mode of transportation. For example, if the “avoid hills” option is selected for cycling, the electronic device presents a plurality of suggested cycling routes that avoid hills but if the “avoid hills” option is selected for cycling, the electronic device presents a plurality of suggested cycling routes that include hills. In some embodiments, transportation preferences change depending on the mode of transportation. For example, the first set of transportation preferences are set for the first mode of transportation (e.g., driving) while the second set of transportation preferences are set for the second mode of transportation (e.g., biking). Thus, for the driving mode of transportation, the first electronic device optionally presents the plurality of suggested routes that comply with transportation preferences set for the driving mode of transportation. (e.g., avoid tolls and/or avoid highways). In another example, for the biking mode of transportation, the first electronic device optionally presents the plurality of suggested routes that comply with transportation preferences set for the biking mode of transportation (e.g., avoid hills and/or avoid busy roads). In some embodiments, if the first electronic device determines that a set of transportation preferences corresponding to another mode of transportation (e.g., walking), the plurality of suggested routes presented in the route configuration user interface comply with the set of transportation preferences corresponding to the walking mode of transportation. For example, the set of transportation preferences corresponding to the walking mode of transportation include invoking one or more respective user interface elements interactable to access one or more respective functions of the first electronic device (e.g., as described in more detail below and/or method 700). For example, the one or more respective functions include presenting immersive (e.g., augmented reality) walking directions, presenting personalized walking guides, and/or presenting indoor maps or trail/park maps. In some embodiments, the first set of transportation preferences and/or the second set of transportation preferences have been previously set by the user (e.g., before finalizing the route and/or initiating navigation instructions for traversing the route) in the route configuration user interface or another user interface, different from the route configuration user interface such as a settings user interface of the mapping application. In some embodiments, the first set of transportation preferences and/or the second set of transportation preferences are learned (and optionally, automatically set by the first electronic device) from prior interactions with the one or more respective user interface elements interactable to access one or more respective functions as described herein and/or learned from one or more operating changes (e.g., transitions from operating according to the first mode of transportation to operating according to the second mode of transportation as described in method 700). Providing a plurality of suggested routes that complies with transportation preferences set by the user enhances interactions with the first electronic device (e.g., by reducing the amount of time needed for the user of the electronic device to set the transportation preferences), which reduces power usage and improves battery life of the electronic device by enabling the user to use the electronic device more quickly and efficiently.

In some embodiments, while operating in the respective mode of transportation, in accordance with a determination that one or more criteria are satisfied, including a criterion that is satisfied when a change in contextual information indicates an end of the respective mode of transportation (e.g., as described in more detail with reference to method 700), the first electronic device displays, via the display generation component, the plurality of selectable options for selecting the plurality of suggested routes using the other modes of transportation. In some embodiments, the other modes of transportation correspond to the one or more criteria and/or the change in contextual information. For example, while presenting public transportation navigation directions, in response to detecting that the user is walking (e.g., based on motion and/or pedometer data), the electronic device displaying a suggested route for walking. In some embodiments, the other modes of transportation are optionally the same or different from the respective mode of transportation. In some embodiments and as described above, the plurality of selectable options for selecting the plurality of suggested routes using the other modes of transportation is displayed while a respective destination using the respective mode of transportation is included in the route. In some embodiments, displaying the plurality of suggested routes is consistent, but not limited to the descriptions described herein and/or with reference to method 700. Automatically displaying the plurality of suggested routes using other modes of transportation in response to the change in contextual information indicative of the end of the respective mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, the first electronic device (e.g., 500a) is in communication with a second electronic device (e.g., 500b), such as in FIG. 6G. In some embodiments, the second electronic device is different from the first electronic device. In some embodiments, the second electronic device is used by a user different from the user of the first electronic device. In some embodiments, the second electronic device includes devices described with reference to method 700. In some embodiments, the first device and second device communicate using text message, instant messaging, phone call, and/or videoconference using an internet or other network connection. In some embodiments, while the first destination using the first mode of transportation and the second destination using the second mode of transportation are included in the route, the first electronic device detects, via the one or more input devices, a third user input corresponding to a request to share the route such as selecting user interface element 850c in FIG. 8I. In some embodiments, the route configuration user interface includes a sharing option and detecting the input includes detecting selection of the sharing option. In some embodiments, in response to detecting the third input, such as selection of user interface element 850c in FIG. 8I, the first electronic device (e.g., 500a) initiates a process for sharing the route with the second electronic device. In some embodiments, initiating a process for sharing the route with the second electronic device includes displaying a user interface for selecting one or more electronic device(s) (e.g., contact(s) from a contact list) including the second electronic device to share the route with. In some embodiments, initiating the process for sharing the route with the second electronic device includes displaying options for sharing the entire route or sharing one or more segments of the route. For example, when the first electronic device receives a series of destinations, each segment is optionally treated separately (e.g., from a first location to a first destination is a first segment, then the first destination to a second destination is a second segment of the route). In some embodiments, initiating a process for sharing the route with the second electronic device includes sharing the route with the second electronic device without requiring additional user input. In some embodiments, sharing the route with the second electronic device includes sharing an estimated time of arrival, turn by turn updates, mode of transportation changes, and/or real-time progress navigating along the route. Initiating a process for sharing the route with the second electronic device while the first destination using the first mode of transportation and the second destination using the second mode of transportation are included in the route simplifies the interaction between the user and the first electronic device and enhances the operability of the first electronic device (e.g., by providing a sharing option without having to navigate to another application and/or user interface).

In some embodiments, the first electronic device (e.g., 500a) detects, via the one or more input devices, a third user input for adding to the route, wherein the third user input specifies a third mode of transportation without specifying a third destination, such as selecting selectable user interface element 814e in FIG. 8G to display a plurality of different modes of transportation as shown in FIG. 8F. In some embodiments, in response to detecting the third user input, the first electronic device initiates a search for the third destination based on the third mode of transportation, such as a search similar to the search shown in FIG. 8C. In some embodiments, detecting the third input for adding to the route is while the first destination using the first mode of transportation is included in the route. In some embodiments, detecting the third user input for adding to the route is while the second destination using the second mode of transportation is included in the route. In some embodiments, detecting the third user input for adding to the route is while initiating navigation instructions for traversing the route without the first destination included in the route. In some embodiments, initiating a search for the third destination based on the third mode of transportation includes displaying one or more user interface objects for selecting categories of destinations, such as restaurants, gas stations, fast food, dinner, parking, convenience stores, coffee shops, etc. In some embodiments, the categories presented are relevant to the third mode of transportation. For example, if the third mode of transportation is biking, the first electronic device optionally presents, but is not limited to presenting, the following categories of destinations: bike trails, bike shops, bicycle parking, bike sharing stations, restaurants, fast food, and/or dinner. In another example, if the third mode of transportation is driving, the first electronic device optionally presents, but is not limited to presenting, the following categories of destinations: gas stations, parking, car repair shops, car wash, electric vehicle charging, restaurants, fast food, and/or dinner. In some embodiments, and prior to the user finalizing the route and/or initiating navigation instructions for traversing the route, the first electronic device detects the third input for adding to the route the third mode of transportation without specifying the third destination. For example, the user optionally provides input to select the category of destination (e.g., coffee stop) to the route. Accordingly, the first electronic device optionally centers the search for the third destination (e.g., coffee shop) based on the third mode of transportation around the electronic device's current location at the time the third user input is detected. In some embodiments, the results of the search include results corresponding to the search (e.g., that match the category of destination) that are located within a geographic area, but not results corresponding to the search that are located outside of the geographic area. In some embodiments, the geographic area is an area that is centered on the current location of the electronic device at the time the third user input is detected, and extends radially from the current location by an amount based on the third mode of transportation. For example, if the third mode of transportation is walking, the amount (e.g., 0.1, 0.3, 0.5, 1, 1.5, 2, 2.5, 3, 3.5, 4, 4.5, or 5 miles) is optionally shorter than if the third mode of transportation is driving. In another example, if the third mode of transportation is driving, the geographic area is an area that is accessible by driving. Thus, traveling by driving to Angel Island State Park in San Francisco Bay is not available and optionally not included as the results of the search for the third destination using the third mode of transportation. In some embodiments, the geographic area includes the current location of the electronic device at the time the third user input is detected, a starting location of the route and/or destinations included in the route if those destinations are within the above-described radial extension from the current location of the electronic device at the time the third user input is detected. Searching for a destination based only on receiving a mode of transportation enhances interactions with the first electronic device (e.g., by automatically focusing the search on destinations relevant to the mode of transportation), which reduces the need for additional inputs for specifying a destination when faster interaction is desired.

In some embodiments, while navigating along the route to the first destination using the first mode of transportation, the first electronic device displays, via the display generation component, a first navigation user interface that includes one or more first user interface elements interactable to access one or more first functions of the first electronic device, such as the user interface displayed by device 500b in FIG. 8G. In some embodiments, while navigating along the route to the second destination using the second mode of transportation, the first electronic device displays, via the display generation component, a second navigation user interface that includes one or more second user interface elements interactable to access one or more second functions of the first electronic device, the one or more second user interface elements different from the one or more first user interface elements, such as the user interface displayed in FIG. 8H. In some embodiments, the second navigation user interface includes the one or more second user interface elements not included in the first navigation user interface. In some embodiments, the first navigation user interface includes one or more first user interface elements not included in the second navigation user interface. In some embodiments, when the first mode of transportation corresponds to driving, the one or more first functions of the first electronic device include an in-car user interface display, zooming in and out a map view, turn-by-turn directions, traffic conditions, and/or estimated travel time and does not include one or more of the user interface elements of the walking, biking, and/or transit user interfaces described below. In some embodiments, the second mode of transportation does not include the one or more first functions associated with the first mode of transportation. For example, if the second mode of transportation is walking, the second mode of transportation includes one or more second functions, different from the one or more first functions, such as immersive walking directions shown in augmented reality, three-dimensional map views, and/or step-by-step walking directions and does not include one or more of the user interface elements of the in-car user interface described above and/or the cycling and/or transit user interfaces described below. In some embodiments, when the mode of transportation corresponds to biking, the one or more functions include ride elevation, information on whether segments of the route include bike lanes, information related to how busy a street is, information on whether there are stairs, steep hills, or bike parking racks along the route, and/or voice-guided bicycling directions and does not include one or more of the user interface elements of the walking and/or in-car user interfaces described above and/or transit functions described below. In some embodiments, when the mode of transportation corresponds to public transit, the one or more functions include location(s) of transit stations, embarkation and disembarkation information, and/or real-time transit information including transit schedules, departure and arrival times, connection information, and outages and does not include one or more elements of the walking, driving, and/or cycling user interfaces described above. Automatically displaying different user interfaces including respective user interface elements for performing respective functions corresponding to the mode of transportation avoids additional interaction between the user and the first electronic device associated with inputting a change in the mode of transportation when seamless transition between transportation modes is desired, thereby reducing errors in the interaction between the user and the first electronic device and reducing inputs needed to correct such errors.

In some embodiments, while navigating along the route using the first mode of transportation, in accordance with a determination that one or more criteria are satisfied, the one or more criteria associated with the second mode of transportation, the first electronic device ceases to navigate along the route using the first mode of transportation, such as transitioning from the user interface in FIG. 8G to the user interface in FIG. 8H. In some embodiments, the one or more criteria include a criterion indicative of completion of navigating along the route using the first mode of transportation and/or the start of navigating along the route using the second mode of transportation. In some embodiments, the one or more criteria include criterion described above and/or with reference to method 700. In some embodiments, the electronic device continues to display the navigation user interface and ceases presenting navigation directions using the first mode of transportation. For example, the electronic device continues to display a representation of the current location of the electronic device on the map and ceases display of an indication of the next maneuver to perform in the navigation directions using the first mode of transportation. In some embodiments, the first electronic device (e.g., 500a) initiates a process to continue to navigate along the route using the second mode of transportation. In some embodiments, initiating a process to continue to navigate along the route using the second mode of transportation includes navigating along the route using the second mode of transportation using the second mode of transportation without requiring additional user input. Thus, the first electronic device optionally does not pause navigating along the route using the second mode of transportation instead of the first mode of transportation. In some embodiments, pausing the navigation along the route includes ceasing to display or otherwise provide navigation instructions for performing the next maneuver on the route. In some embodiments, continuing to navigate along the route using the second mode of transportation includes displaying an indication of an upcoming maneuver included in the navigation directions using the second mode of transportation. In some embodiments, the route using the second mode of transportation is different from the route using the first mode of transportation.

In some embodiments, the first electronic device presents, via one or more output devices in communication with the first electronic device, an indication of changing from the first mode of transportation to the second mode of transportation, such as shown in FIG. 8F where the user selects to change the mode of transportation from driving 824a to walking 824b. In some embodiments, initiating a process to continue to navigate along the route using the second mode of transportation includes displaying the indication of changing from the first mode of transportation to the second mode of transportation. In some embodiments, the indication includes a graphical image and/or text description describing the second mode of transportation. In some embodiments, the indication includes a prompt to the user to accept or decline ceasing to navigate along the route using the first mode of transportation and continuing to navigate along the route using the second mode of transportation. In some embodiments, the first electronic device automatically transitions to navigating along the route using the second mode of transportation after a period of time (e.g., 5, 10, 15, 20, 25, 30, 35, or 40 seconds). In some embodiments, the indication of changing from the first mode of transportation to the second mode of transportation is presented prior to the first electronic device navigating along the route using the second mode of transportation. In some embodiments, initiating a process to continue to navigate along the route using the second mode of transportation includes pausing navigating along the route using the first mode of transportation and resuming navigating along the route using the second mode of transportation. In some embodiments, initiating the process to continue to navigate along the route using the second mode of transportation is based on a condition that the computer system receives acceptance to cease navigating along the route using the first mode of transportation and instead, use the second mode of transportation. In some embodiments, the acceptance is indicated by detection of an appropriate movement of the first electronic device along the route (e.g., movement indicative of using the second mode of transportation as described with reference to method 700). Automatically displaying an indication that the first electronic device will transition to operating according to the second mode of transportation without receiving user input avoids additional interaction between the user and the first electronic device associated with inputting a change in the mode of transportation when seamless transition between transportation modes is desired, thereby reducing errors in the interaction between the user and the first electronic device and reducing inputs needed to correct such errors by providing improved visual feedback to the user.

In some embodiments, the first electronic device (e.g., 500a) is included in a plurality of electronic devices associated with a user account of the first electronic device (e.g., 500a). In some embodiments, the plurality of electronic devices associated with the user account are logged into the user account and able to access account settings, purchases, and/or communication sessions associated with the user account. In some embodiments, while navigating alone the route using the first mode of transportation, the first electronic device (e.g., 500a) presents a navigation user interface using a second electronic device (e.g., 500b) of the plurality of electronic devices associated with the user account, such as in FIG. 8G. In some embodiments, the second electronic device is the same as the first electronic device described herein. In some embodiments, the second electronic device is different from the first electronic device. In some embodiments, while navigating along the route using the second mode of transportation, the first electronic device presents the navigation user interface using a third electronic device of the plurality of electronic devices associated with the user account. In some embodiments, the third electronic device is the same as the first electronic device described herein. In some embodiments, the third electronic device is different from the first electronic device. For example, the second electronic device and/or the third electronic device is optionally a wearable device (e.g., watch), and/or a motorized vehicle. In some embodiments, the first electronic device is configured to stream or share navigation data (e.g., route data and/or navigation directions) to one or more external devices (e.g., the second electronic device and/or the third electronic device) or mirror navigation data for presentation on the one or more external devices or displays. The one or more external devices or displays include watch devices, head-mounted devices, or motorized vehicle displays. In some embodiments, the first electronic device and the one or more external devices or displays are configured to present different navigation user interfaces based on the mode of transportation as described in above. In some embodiments, the first electronic device is configured to share navigation data to another electronic device that is not part of the plurality of electronic devices associated with the user (e.g., the another electronic device is associated with another user, different from the user) as described herein. In some embodiments, the third electronic device automatically begins presenting the navigation directions in accordance with beginning the portion of the route that uses the second mode of transportation without receiving a user input requesting to cease presentation of the navigation instructions using the second electronic device and/or a user input requesting to present the navigation instructions using the third electronic device. Permitting the sharing and/or display of navigation data to a plurality of electronic devices, different from the first electronic device, avoids additional interaction between the user and the plurality of electronic devices (e.g., the user does not need to perform the same navigation request in the plurality of electronic devices already configured in the first electronic device), which, reduces power usage of the plurality of electronic devices.

In some embodiments, the route configuration user interface, such as in FIGS. 8A-8F, includes one or more user interface elements interactable to permit reservation or payment of a good or service associated with the first mode of transportation or the second mode of transportation. In some embodiments, the electronic device displays a user interface element for permitting reservation or payment of a good or service associated with the first mode of transportation in response to the first mode of transportation being added to the route. In some embodiments, the electronic device displays a user interface element for permitting reservation or payment of a good or service associated with the second mode of transportation in response to the second mode of transportation being added to the route. In some embodiments, the one or more user interface elements include application extensions (e.g., parking reservation system, toll payment system, public transit payment system, or bikeshare rental system) that provide application specific information (e.g., parking availability, public transit schedule, or bikeshare availability) and/or perform application specific functions (e.g., purchasing public transit ticket, purchasing reservations, or reserving bike rental). In some embodiments, the application extensions are part of the mapping application. In some embodiments, the application extensions is separate from the mapping application (e.g., separate executable software that includes software executing in the background of the mapping application). In some embodiments, the application extensions provide APIs accessible to the mapping application to provide application specific information and/or perform application specific functions. Providing a way to perform specific transportation mode-based services via the mapping application avoids switching to that specific application to perform the specific transportation-based services when seamless transition between is desired, thereby reducing errors in the interaction between the user and the first electronic device and reducing inputs needed to correct such errors.

In some embodiments, adding the second destination using the second mode of transportation to the route in response to detecting the second user input includes the first electronic device (e.g., 500a) detecting, via the one or more input devices, a respective user input corresponding to a request to add the second destination to the route without specifying a mode of transportation, such as entering the destination in user interface element 818b in FIG. 8C. In some embodiments, detecting the respective user input corresponding to the request to add the second destination to the route is while the first destination using the first mode of transportation is included in the route. In some embodiments, detecting the respective user input corresponding to the request to add the second destination to the route is while the second destination using the second mode of transportation is included in the route. In some embodiments, detecting the respective user input corresponding to the request to add the second destination to the route is while initiating navigation instructions for traversing the route without the second destination included in the route. In some embodiments, in response to the respective user input, the first electronic device (e.g., 500a) displays, via the display generation component (e.g., 504a), an option to use the second mode of transportation to navigate to the second destination and an option to use a third mode of transportation different from the second mode of transportation to navigate to the second destination, wherein detecting the second user input includes detecting selection of the option to use the second mode of transportation to navigate to the second destination, such as user interface element 814h of FIG. 8G showing two different route options. In some embodiments, the first electronic device presents the option to navigate to the second destination using at least two modes of transportation different from one another. In some embodiments, the first electronic device presents an option to navigate to the second destination using the first mode of transportation. In some embodiments, the second user input corresponding to the request to add the second destination to the route includes selection of the option to use the second mode of transportation to navigate to the second destination. In some embodiments, while navigating alone the route using the second mode of transportation, and in accordance with a determination that one or more criteria described above are satisfied, the first electronic device ceases to navigate along the route using the second mode of transportation and continues to navigate along the route using the option to use the third mode of transportation. For example, the user optionally provides input to add the second destination (e.g., hotel in Los Angeles) to the route. Accordingly, the first electronic device optionally includes two different modes of transportations to navigate to the destination such as flying and using rideshare to the second destination. Automatically adding a second mode of transportation to reach the destination enhances interactions with the first electronic device, which reduces the need for additional inputs for specifying a destination when faster interaction is desired.

In some embodiments, while the second destination using the second mode of transportation is included in the route, such as in FIG. 8F, the first electronic device (e.g., 500a) detects, via the one or more input devices, a third user input corresponding to a request to search for a third destination to be added to the route. In some embodiments, in response to detecting the third user input, the first electronic device (e.g., 500a) initiates a search for the third destination in a geographic area that includes the second destination using the second mode of transportation, such as in FIG. 8C. In some embodiments, the first electronic device will center the search for the third destination on the second geographic area corresponding to the second destination using the second mode of transportation described above such that the results of the search include results corresponding to the search (e.g., that match a search for a specified destination and/or that match the category of destination based on the mode of transportation as described above) that are located within the second geographic area, but not results corresponding to the search that are located outside of the second geographic area. In some embodiments, in response to detecting the third input while the first destination is included in the route and the second destination is not included in the route, the electronic device initiates the search for the third destination in a geographic area that includes the first destination using the first mode of transportation. Centering a search for the third destination around the second geographic area based on the third user input focuses the search on the user desired location and provides the user with the closest options to the second geographic area using the second mode of transportation, thereby reducing the need for subsequent inputs for correcting searches in areas not desired by the user.

In some embodiments, while the first destination using the first mode of transportation is included in the route (and the second destination using the second mode of transportation is included in the route), such as in FIG. 8B, the first electronic device (e.g., 500a) detects, via the one or more input devices, a third user input corresponding to a request to search for a third destination to be added to the route (between the first and second destinations). In some embodiments, in response to detecting the third user input and in accordance with a determination that the third destination is being added to the route after the first destination (and before the second destination), the first electronic device (e.g., 500a) initiates a search for the third destination in a geographic area that includes the first destination using the first mode of transportation, such as in FIG. 8C. In some embodiments, the first electronic device will center the search for the third destination on the first geographic area corresponding to the first destination using the first mode of transportation described above such that the results of the search include results corresponding to the search (e.g., that match a search for a specified destination and/or that match the category of destination based on the mode of transportation as described above) that are located within the first geographic area, but not results corresponding to the search that are located outside of the first geographic area. Centering a search for the third destination around the first geographic area based on the third user input focuses the search on the user desired location and provides the user with the closest options to the first geographic area using the first mode of transportation, thereby reducing the need for subsequent inputs for correcting searches in areas not desired by the user.

In some embodiments, the first electronic device (e.g., 500a) displays, via the display generation component, one or more search results corresponding to locations for servicing the first mode of transportation, such as in a search user interface similar to FIG. 8C. In some embodiments, and as described herein the one or more search results include points of interest and/or categories relevant to the mode of transportation. In some embodiments, in accordance with a determination that the first mode of transportation is a first respective mode of transportation, the electronic device displays a first respective plurality of search results for servicing the first respective mode of transportation. In some embodiments, in accordance with a determination that the first mode of transportation is a second respective mode of transportation, the electronic device displays a second respective plurality of search results for servicing the second respective mode of transportation. For example, if the first mode of transportation is biking, the first electronic device optionally presents, but is not limited to the following categories of destinations: bike shops, bike racks, and/or bike rentals. As another example, if the first mode of transportation is driving, the first electronic device optionally presents, but is not limited to the following categories of destinations: gas stations, electric vehicle charging stations, and/or automobile mechanics. Including points of interest relevant to the mode of transportation being used in searching for a destination enhances interactions with the first electronic device, which reduces the need for additional search inputs for searching for points of interest relevant to the mode of transportation when faster interaction is desired.

In some embodiments, in accordance with a determination that the second mode of transportation is a first respective mode of transportation, the second destination is a first respective destination. In some embodiments, the first respective destination corresponds to the first respective mode of transportation. In some embodiments, in accordance with a determination that the second mode of transportation is a second respective mode of transportation different from the first respective mode of transportation, the second destination is a second respective destination different from the first respective destination. In some embodiments, the second respective destination corresponds to the second respective mode of transportation. In some embodiments, the first electronic device identifies one or more variations (e.g., recommendations to make navigating along the route or to the second location easier, more efficient, or to view sights or locations of interest along the way) based on content specific to the space and/or the mode of transportation as described with reference to method 700. For example, when the second mode of transportation corresponds to walking, the first respective destination within the space proposed or recommended by the first electronic device is optionally “entrance 100” of the venue. In some embodiments, when the second mode of transportation corresponds to biking, the second respective destination within the space proposed or recommended by the first electronic device is optionally different from “entrance 100” and is instead “bicycle parking A” of the venue. Determining a more precise destination according to the mode of transportation without receiving user input avoids additional interaction between the user and the first electronic device associated with inputting a change in destination when seamless transition between transportation modes is desired, thereby reducing errors in the interaction between the user and the first electronic device and reducing inputs needed to correct such errors.

In some embodiments, adding the second destination using the second mode of transportation to the route in response to detecting the second user input includes the first electronic device (e.g., 500a) detecting, via the one or more input devices, a respective user input corresponding to a request to add the second destination to the route and a mode of transportation, such as in FIGS. 8A-8C. In some embodiments, detecting the respective user input corresponding to the request to add the second destination to the route is while the first destination using the first mode of transportation is included in the route. In some embodiments, detecting the respective user input corresponding to the request to add the second destination to the route is while the second destination using the second mode of transportation is included in the route. In some embodiments, detecting the respective user input corresponding to the request to add the second destination to the route is while initiating navigation instructions for traversing the route without the second destination included in the route.

In some embodiments, such as in FIG. 8E, in response to the respective user input, the first electronic device displays, via the display generation component, an option (e.g., 824b) to use the second mode of transportation to navigate for a first segment of the route to the second destination and an option (e.g., 824c) to use a third mode of transportation to navigate for a second segment of the route to the second destination, wherein detecting the second user input includes detecting selection (e.g., with contact 826) of the option (e.g., 824b) to use the second mode of transportation to navigate to the second destination. In some embodiments, the first electronic device presents the option to navigate to the second destination using at least two modes of transportation. In some embodiments, presenting the option to navigate to the second destination using at least two modes of transportation includes the first segment of the route corresponding to first one or more directions to the second destination using the second mode of transportation. In some embodiments, the second segment of the route corresponds to second one or more directions to the second destination using the third mode of transportation. In some embodiments, the second user input corresponding to the request to add the second destination to the route includes selection of the option to use the second mode of transportation to navigate for the first segment of the route to the second destination. In some embodiments, while navigating alone the route for the first segment using the second mode of transportation, and in accordance with a determination that one or more criteria described above are satisfied, the first electronic device ceases to navigate along the route for the first segment using the second mode of transportation and continues to navigate along the route using the third mode of transportation to navigate for the second segment of the route to the second destination. For example, the user optionally provides input to add the second destination (e.g., Crissy Field) to the route. Accordingly, the first electronic device optionally includes two different modes of transportations to navigate to the destination such as using public transit to the end of the transit line for the first segment of the route and walking for the second segment to the second destination. Automatically adding a second segment using a second mode of transportation to reach the destination enhances interactions with the first electronic device, which reduces the need for additional inputs for specifying a destination when faster interaction is desired.

In some embodiments, while displaying the route configuration user interface, while the second destination using the second mode of transportation is included in the route, the first electronic device displays, via the display generation component, one or more first route segments using the second mode of transportation to the second destination, such as user interface element 814h in FIG. 8F which includes two different route options which each include content indicating the length of time to reach the second destination using the second mode of transportation. In some embodiments, prior to the electronic device finalizing the route and/or initiating navigation instructions for traversing the route, the first electronic device displays the route configuration user interface including one or more selectable options for selecting one or more suggested route segments using the second mode of transportation. In some embodiments, the one or more suggested route segments using the second mode of transportation are based on contextual information and/or user preferences described herein and with reference to method 700. In some embodiments, such as in FIG. 8F, while displaying the one or more first route segments, the first electronic device (e.g., 500a) detects, via the one or more input devices, a third user input (e.g., via contact 828) corresponding to a request to navigate to the second destination using a first route segment of the one or more first route segments using the second mode of transportation. In some embodiments, in response to detecting the third user input, the first electronic device adds the first route segment using the second mode of transportation to the route, such as in FIG. 8G. In some embodiments, the route includes navigation directions using the first mode of transportation from the first location to the first destination, and navigation directions using the second mode of transportation from the first destination to the second destination using the first route segment. In some embodiments, the second destination using the first route segment is added after the first destination in the route. In some embodiments, the second destination using the first route segment is added before the first destination in the route. Adding a destination using a particular mode of transportation and a particular route segment to the route provides an efficient way of presenting information relevant to the mode of transportation, which reduces power usage and improves battery life of the electronic device by enabling the user to use the electronic device more quickly and efficiently.

It should be understood that the particular order in which the operations in FIG. 9 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 900 described above with respect to FIG. 9. For example, the operation of the electronic device to present route planning user interfaces for planning routes with two or more modes of transportation change transportation modes in accordance with a change in contextual information described above with reference to method 900 optionally has one or more of the characteristics of changing transportation modes in accordance with a change in contextual information described herein with reference to other methods described herein (e.g., method 700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 9 are, optionally, implemented by components depicted in FIGS. 1A-1B. For example, displaying operation 902a and detecting operation 902d are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to improve the ability for users to search for stops in multiple stop routes. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to identify the location of the user. Further, other uses for personal information data that benefit the user are also contemplated by the present disclosure. For instance, location data may be used to provide navigation directions.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of location services, the present technology can be configured to allow users to select to “opt in” or “opt out” of participation in the collection of personal information data during registration for services or anytime thereafter. In another example, users can select not to provide personal data and/or device or object location data. In yet another example, users can select to limit the length of time personal data and/or device or object location data is maintained or entirely block the development of a baseline location profile. In addition to providing “opt in” and “opt out” options, the present disclosure contemplates providing notifications relating to the access or use of personal information. For instance, a user may be notified upon downloading an application that their personal information data and/or location data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at a first electronic device in communication with a display generation component and one or input devices:
while displaying, via the display generation component, a route configuration user interface, detecting, via the one or more input devices, a first user input corresponding to a request to add a first destination to a route using a first mode of transportation;
in response to detecting the first user input, adding the first destination using the first mode of transportation to the route;
detecting, via the one or more input devices, a second user input corresponding to a request to add a second destination to the route using a second mode of transportation, different from the first mode of transportation; and
in response to detecting the second user input, adding the second destination using the second mode of transportation to the route.

2. The method of claim 1, further comprising:
while a respective destination using a respective mode of transportation is included in the route, displaying, via the display generation component, a plurality of selectable options for selecting a plurality of suggested routes using other modes of transportation, different from the respective mode of transportation, for navigating to the respective destination.

3. The method of claim 1, wherein:
in accordance with a determination that a first set of transportation preferences are selected by a user of the first electronic device, the plurality of suggested routes comply with the first set of transportation preferences; and
in accordance with a determination that a second set of transportation preferences different from the first set of transportation preferences are selected by a user of the first electronic device, the plurality of suggested routes comply with the second set of transportation preferences.

4. The method of claim 2, further comprising:
while operating in the respective mode of transportation, in accordance with a determination that one or more criteria are satisfied, including a criterion that is satisfied when a change in contextual information indicates an end of the respective mode of transportation, displaying, via the display generation component, the plurality of selectable options for selecting the plurality of suggested routes using the other modes of transportation.

5. The method of claim 1, wherein the first electronic device is in communication with a second electronic device, the method further comprising:
while the first destination using the first mode of transportation and the second destination using the second mode of transportation are included in the route, detecting, via the one or more input devices, a third user input corresponding to a request to share the route; and
in response to detecting the third input, initiating a process for sharing the route with the second electronic device.

6. The method of claim 1, further comprising:
detecting, via the one or more input devices, a third user input for adding to the route, wherein the third user input specifies a third mode of transportation without specifying a third destination; and
in response to detecting the third user input, initiating a search for the third destination based on the third mode of transportation.

7. The method of claim 1, further comprising:
while navigating along the route to the first destination using the first mode of transportation, displaying, via the display generation component, a first navigation user interface that includes one or more first user interface elements interactable to access one or more first functions of the first electronic device; and
while navigating along the route to the second destination using the second mode of transportation, displaying, via the display generation component, a second navigation user interface that includes one or more second user interface elements interactable to access one or more second functions of the first electronic device, the one or more second user interface elements different from the one or more first user interface elements.

8. The method of claim 1, further comprising:
while navigating along the route using the first mode of transportation, in accordance with a determination that one or more criteria are satisfied, the one or more criteria associated with the second mode of transportation:
ceasing to navigate along the route using the first mode of transportation;
initiating a process to continue to navigate along the route using the second mode of transportation; and
presenting, via one or more output devices in communication with the first electronic device, an indication of changing from the first mode of transportation to the second mode of transportation.

9. The method of claim 1, wherein the first electronic device is included in a plurality of electronic devices associated with a user account of the first electronic device, and the method further comprises:
while navigating along the route using the first mode of transportation, presenting a navigation user interface using a second electronic device of the plurality of electronic devices associated with the user account; and
while navigating along the route using the second mode of transportation, presenting the navigation user interface using a third electronic device of the plurality of electronic devices associated with the user account.

10. The method of claim 1, wherein the route configuration user interface includes one or more user interface elements interactable to permit reservation or payment of a good or service associated with the first mode of transportation or the second mode of transportation.

11. The method of claim 1, wherein adding the second destination using the second mode of transportation to the route in response to detecting the second user input includes:
detecting, via the one or more input devices, a respective user input corresponding to a request to add the second destination to the route without specifying a mode of transportation; and
in response to the respective user input, displaying, via the display generation component, an option to use the second mode of transportation to navigate to the second destination and an option to use a third mode of transportation different from the second mode of transportation to navigate to the second destination, wherein detecting the second user input includes detecting selection of the option to use the second mode of transportation to navigate to the second destination.

12. The method of claim 1, further comprising:
while the second destination using the second mode of transportation is included in the route, detecting, via the one or more input devices, a third user input corresponding to a request to search for a third destination to be added to the route; and
in response to detecting the third user input, initiating a search for the third destination in a geographic area that includes the second destination using the second mode of transportation.

13. The method of claim 1, further comprising:
while the first destination using the first mode of transportation is included in the route, detecting, via the one or more input devices, a third user input corresponding to a request to search for a third destination to be added to the route; and
in response to detecting the third user input and in accordance with a determination that the third destination is being added to the route after the first destination, initiating a search for the third destination in a geographic area that includes the first destination using the first mode of transportation.

14. The method of claim 13, wherein the search for the third destination includes:
displaying, via the display generation component, one or more search results corresponding to locations for servicing the first mode of transportation.

15. The method of claim 1, wherein:
in accordance with a determination that the second mode of transportation is a first respective mode of transportation, the second destination is a first respective destination; and
in accordance with a determination that the second mode of transportation is a second respective mode of transportation different from the first respective mode of transportation, the second destination is a second respective destination different from the first respective destination.

16. The method of claim 1, wherein adding the second destination using the second mode of transportation to the route in response to detecting the second user input includes:
detecting, via the one or more input devices, a respective user input corresponding to a request to add the second destination to the route and a mode of transportation; and
in response to the respective user input, displaying, via the display generation component, an option to use the second mode of transportation to navigate for a first segment of the route to the second destination and an option to use a third mode of transportation to navigate for a second segment of the route to the second destination, wherein detecting the second user input includes detecting selection of the option to use the second mode of transportation to navigate to the second destination.

17. The method of claim 1, further comprising:
while displaying the route configuration user interface:
while the second destination using the second mode of transportation is included in the route, displaying, via the display generation component, one or more first route segments using the second mode of transportation to the second destination;
while displaying the one or more first route segments, detecting, via the one or more input devices, a third user input corresponding to a request to navigate to the second destination using a first route segment of the one or more first route segments using the second mode of transportation; and
in response to detecting the third user input, adding the first route segment using the second mode of transportation to the route.

18. An electronic device, comprising:
one or more processors;
memory; and
one or more programs, wherein the one or more programs are stored in the memory and configured to be executed by the one or more processors, the one or more programs including instructions for:
while displaying, via a display generation component, a route configuration user interface, detecting, via one or more input devices, a first user input corresponding to a request to add a first destination to a route using a first mode of transportation;
in response to detecting the first user input, adding the first destination using the first mode of transportation to the route;
detecting, via the one or more input devices, a second user input corresponding to a request to add a second destination to the route using a second mode of transportation, different from the first mode of transportation; and
in response to detecting the second user input, adding the second destination using the second mode of transportation to the route.

19. A non-transitory computer readable storage medium storing one or more programs, the one or more programs comprising instructions, which when executed by one or more processors of an electronic device, cause the electronic device to perform a method comprising:
while displaying, via a display generation component, a route configuration user interface, detecting, via one or more input devices, a first user input corresponding to a request to add a first destination to a route using a first mode of transportation;
in response to detecting the first user input, adding the first destination using the first mode of transportation to the route;
detecting, via the one or more input devices, a second user input corresponding to a request to add a second destination to the route using a second mode of transportation, different from the first mode of transportation; and
in response to detecting the second user input, adding the second destination using the second mode of transportation to the route.
